(19) United States
(12) Patent Application Publication
(10) Pub. No.: US 2012/0182912 A1
(43) Pub. Date: Jul. 19, 2012

(54) METHODS, APPARATUS AND SYSTEMS FOR LOCAL INTERNET PROTOCOL ACCESS CONNECTION HANDLING DURING CIRCUIT SWITCHED FALLBACK AND HANDOVER

(75) Inventors: Mahmoud WATFA, Saint Leonard (CA); Peter S. WANG, E. Setauket, NY (US); Kai LIU, S. Huntington, NY (US); Pascal M. ADJAKPLE, Great Neck, NY (US); Ulises OLVERA-HERNANDEZ, Kirkland (CA); Behrouz AGHILI, Commack, NY (US)

(73) Assignee: INTERDIGITAL PATENT HOLDINGS, INC., Wilmington, DE (US)

(21) Appl. No.: 13/348,712

(22) Filed: Jan. 12, 2012

Related U.S. Application Data
(60) Provisional application No. 61/432,834, filed on Jan. 14, 2011.
(60) Provisional application No. 61/439,000, filed on Feb. 3, 2011.
(60) Provisional application No. 61/483,339, filed on May 6, 2011.

(51) Int. Cl. H04W 4/00; H04W 52/02

(52) U.S. Cl. 370/311; 370/328

(57) ABSTRACT

A method and apparatus are described for handling local Internet protocol (IP) access (LIPA) connection during circuit switched fallback (CSFB) and handover (HO). One representative method of managing a Local Internet Protocol Access (LIPA) packet data network (PDN) connection to a wireless transmit/receive unit (WTRU), includes performing a switching operation to switch from the LIPA PDN connection to a non-LIPA PDN connection for communication to the WTRU; and suspending the LIPA PDN connection, in response to the switching operation.

### CROSS REFERENCE TO RELATED APPLICATIONS

This application claims priority from U.S. Provisional Application No. 61/432,834, filed Jan. 14, 2011, U.S. Provisional Application No. 61/439,000, filed Feb. 3, 2011, and U.S. Provisional Application No. 61/483,339, filed May 6, 2011, the contents of each being incorporated herein by reference.

### FIELD OF DISCLOSURE

This application relates to wireless communications and, in particular, methods, apparatus, and systems for handling circuit switched fallback and handover.

### BACKGROUND

Circuit switched fallback has been used to enable voice calls using existing infrastructure and to enable backward compatibility with the existing infrastructure.

### SUMMARY

In one representative embodiment, a method of managing a Local Internet Protocol Access (LIPA) packet data network (PDN) connection to a wireless transmit/receive unit (WTRU), may include performing a switching operation to switch from the LIPA PDN connection to a non-LIPA PDN connection for communication to the WTRU; and suspending the LIPA PDN connection, in response to the switching operation.

In another representative embodiment, a method of managing a Local Internet Protocol Access (LIPA) packet data network (PDN) connection to a LIPA cell after a switching operation to switch a wireless transmit/receive unit (WTRU) from the LIPA PDN connection to a non-LIPA PDN connection for communication is disclosed. The LIPA PDN connection may be suspended after the switching operation. The method may include: sending, by a target system associated with the non-LIPA PDN connection, information for redirection of the WTRU back to the LIPA cell; and controlling redirection of the WTRU from the target system to the LIPA cell associated with the LIPA PDN connection to resume the suspended LIPA PDN connection.

In another representative embodiment, a method of managing a Local Internet Protocol Access (LIPA) packet data network (PDN) connection to a wireless transmit/receive unit (WTRU), may include: performing a switching operation to switch from the LIPA PDN connection to a non-LIPA PDN connection for communication to the WTRU by locally deactivating the LIPA PDN connection, in response to the switching operation, and initiating an attach procedure.

In another representative embodiment, a method of handling idle mode reselections by a wireless transmit/receive unit (WTRU), may include: establishing a local internet protocol access (LIPA) packet data network (PDN) connection; moving from one network to another while in idle mode; and informing a mobility management entity (MME) whether or not the WTRU has a LIPA PDN connection.

In another representative embodiment, a method of managing a wireless transmit/receive unit (WTRU) context when a closed subscriber group (CSG) subscription expires, may include: establishing, by a WTRU, a local internet protocol access (LIPA) packet data network (PDN) connection; attempting, by the WTRU, to access a CSG cell; and receiving, by the WTRU, a message indicating that the WTRU is not authorized to access the CSG after a subscription of the WTRU has expired when the WTRU attempts to access the CSG cell, and the WTRU has one PDN connection for LIPA.

In another representative embodiment, a method of placing an emergency call from a wireless transmit/receive unit (WTRU), may include: sending a service request type with an establishment clause set to emergency; preventing local deregistration of the WTRU using the sent establishment clause; and initiating a packet data network connection for the emergency call.

In another representative embodiment, a method of handling a local internet protocol access (LIPA) packet data network (PDN) connection may include: performing circuit switched fallback; and determining between suspension and deactivation of the LIPA PDN connection.

In another representative embodiment, a method of managing a connection to a wireless transmit/receive unit (WTRU) via a first type of radio access technology (RAT), may include performing a switching operation to switch from the connection via the first type of RAT to a further connection via a second type of RAT for communication to the WTRU; and suspending the connection via the first type of RAT, in response to the switching operation.

In another representative embodiment, a method of managing connections of a wireless transmit/receive unit (WTRU), may include: receiving, by the WTRU, signaling to reattach to a first domain; determining, by the WTRU a type of service that was requested and that resulted in the reception of the signaling to reattach to the first domain, as a determined result; and autonomously reselecting, by the WTRU, to a second domain, based on the determined result.

In another representative embodiment, a method of managing connections of a wireless transmit/receive unit (WTRU) when attempting a handover of the WTRU having a LIPA packet data network (PDN) connection with a first cell, may include: determining, by a Home eNodeB (HeNB), whether a first condition exists; and responsive to the first condition existing: preventing or aborting, by the HeNB, the attempted handover procedure, and redirecting, by the HeNB, the WTRU to a second cell.

In another representative embodiment, a method of managing one or more connections to a wireless transmit/receive unit (WTRU), may include: performing a switching operation to switch from a first connection of the WTRU to a second connection to the WTRU; and suspending the first connection in response to the switching operation for at least a specified period after performing the switching operation.

In another representative embodiment, an apparatus for managing a Local Internet Protocol Access (LIPA) packet data network (PDN) connection, may include: a processor configured to: perform a switching operation to switch from the LIPA PDN connection to a non-LIPA PDN connection for communication to a wireless transmit/receive unit (WTRU); and suspend the LIPA PDN connection, in response to the switching operation.

In another representative embodiment, an apparatus for handling idle mode reselections by a wireless transmit/receive unit (WTRU) when moving from one network to another network while in idle mode, may include: a processor configured to establish a local internet protocol access (LIPA) packet data network (PDN) connection; and a transmit/receive unit configured to inform a mobility management entity (MME) whether or not the WTRU has a LIPA PDN connection.

In another representative embodiment, an apparatus for managing a wireless transmit/receive unit (WTRU) context when a closed subscriber group (CSG) subscription expires, may include: a processor configured to establish a local internet protocol access (LIPA) packet data network (PDN) connection; and a transmit/receive unit configured to: (1) attempt to access a CSG cell; (2) inform a mobility management entity (MME) whether or not the WTRU has a LIPA PDN connection; and (3) receive a message indicating that the WTRU is not authorized to access the CSG after a subscription of the WTRU has expired when the WTRU attempts to access the CSG cell, and the WTRU has a single PDN connection for LIPA.

In another representative embodiment, an apparatus for placing an emergency call, may include: a transmit/receive unit configured to send a service request type with an establishment clause set to indicate an emergency from a wireless transmit/receive unit (WTRU); and a processor configured to prevent local deregistration of the WTRU using the sent establishment clause, and initiate a packet data network connection for the emergency call.

In another representative embodiment, an apparatus for managing a connection via a first type of radio access technology (RAT), may include: a processor configured to: control performance of a switching operation to switch from the connection via the first type of RAT to a further connection via a second type of RAT for communication to a wireless transmit/receive unit (WTRU); and suspend the connection via the first type of RAT, in response to the switching operation.

In another representative embodiment, a wireless transmit/receive unit (WTRU), configured to manage connections, that moves from a local internet protocol access (LIPA) cell having had an established LIPA packet data network (PDN) connection in a first domain, may include: a transmit/receive unit configured to: (1) request a circuit switched call, and (2) receive signaling indicating to reattach to the first domain; a processor configured to disregard the received signaling indicating to reattach to the first domain and autonomously control a redirection of the circuit-switched call in a second domain.

In another representative embodiment, a Home eNodeB (HeNB) for managing connections when attempting a handover of a wireless transmit/receive unit (WTRU) having a LIPA packet data network (PDN) connection with a first cell, may include: a processor configure to: (1) determine whether a first condition exists, and (2) responsive to the first condition: (i) abort the attempted handover procedure, and (ii) redirect the WTRU to a second cell; and (3) release a radio resource control connection.

### BRIEF DESCRIPTION OF THE DRAWINGS

A more detailed understanding may be had from the following description, given by way of example in conjunction with the accompanying drawings. Figures in such drawings, like the detailed description, are examples. As such, the Figures and the detailed description are not to be considered limiting, and other equally effective examples are possible and likely. Furthermore, like reference numerals in the Figures indicate like elements, and wherein:

FIG. 1 is a diagram illustrating an example communication system in which one or more disclosed embodiments may be implemented;

FIG. 2 is a diagram illustrating an example wireless transmit/receive unit (WTRU) that may be used within the communication system illustrated in FIG. 1;

FIGS. 3, 4, and 5 are system diagrams of representative radio access networks and representative core networks that may be used within the communication system illustrated in FIG. 1;

FIG. 6 is a diagram illustrating a representative architecture including a local gateway (LGW) located on a home evolved Node-B (HeNB) which may be used within the communication system illustrated in FIG. 1.

FIG. 7 is a flowchart illustrating a representative method for managing a Local Internet Protocol Access (LIPA) packet data network (PDN) connection;

FIG. 8 is a flowchart illustrating another representative method for managing a Local Internet Protocol Access (LIPA) packet data network (PDN) connection;

FIG. 9 is a flowchart illustrating a representative method for handling reselections by a WTRU;

FIG. 10 is a flowchart illustrating a representative method for managing a WTRU context;

FIG. 11 is a flowchart illustrating a representative method for placing an emergency call;

FIG. 12 is a flowchart illustrating a representative method for handling a LIPA PDN connection;

FIG. 13 is a flowchart illustrating a representative method for managing a connection to a WTRU

FIG. 14 is a flowchart illustrating a representative method for managing connections of a WTRU;

FIG. 15 is a flowchart illustrating a representative method for managing connections of a WTRU; and

FIG. 16 is a flowchart illustrating a representative method for managing connections of a WTRU.

### DETAILED DESCRIPTION

Although the representative embodiments are generally shown hereafter using wireless network architectures, any number of different network architectures may be used including networks with wired components and/or wireless components, for example.

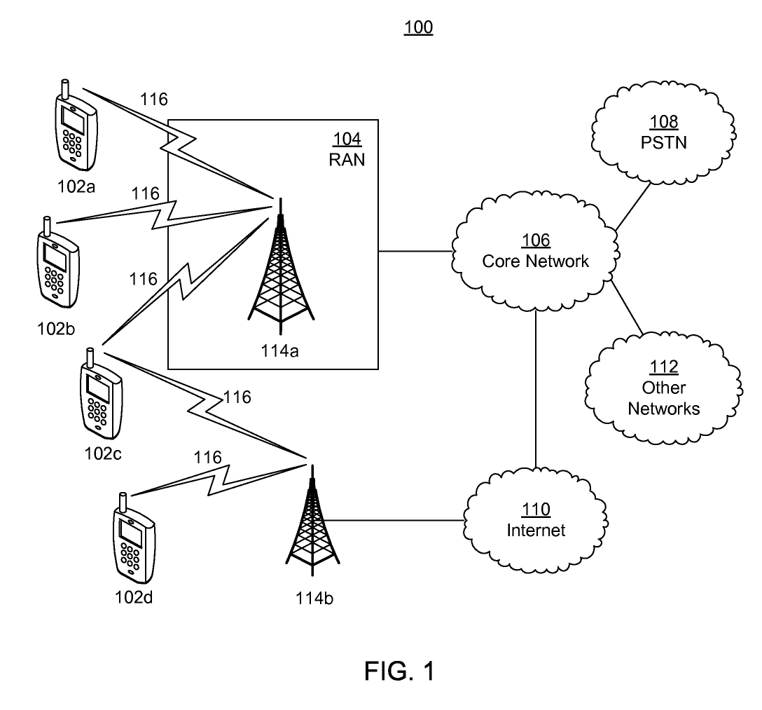

FIG. 1 is a diagram of a representative communications system 100 in which one or more disclosed embodiments may be implemented. The communications system 100 may be a multiple access system that provides content, such as, data, video, messaging, broadcast, etc., to multiple wireless users. The communications system 100 may enable multiple users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1, the communication system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communication systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communication system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunication System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1 may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communication system 100 may include multi-mode capabilities, i.e., the WTRUs 102a, 102b, 102c, 102d may include multiple transceivers for communicating with different wireless networks over different wireless links. For example, the WTRU 102c shown in FIG. 1 may be configured to communicate with the base station 114a, which may employ a cellular-based radio technology, and with the base station 114b, which may employ an IEEE 802 radio technology.

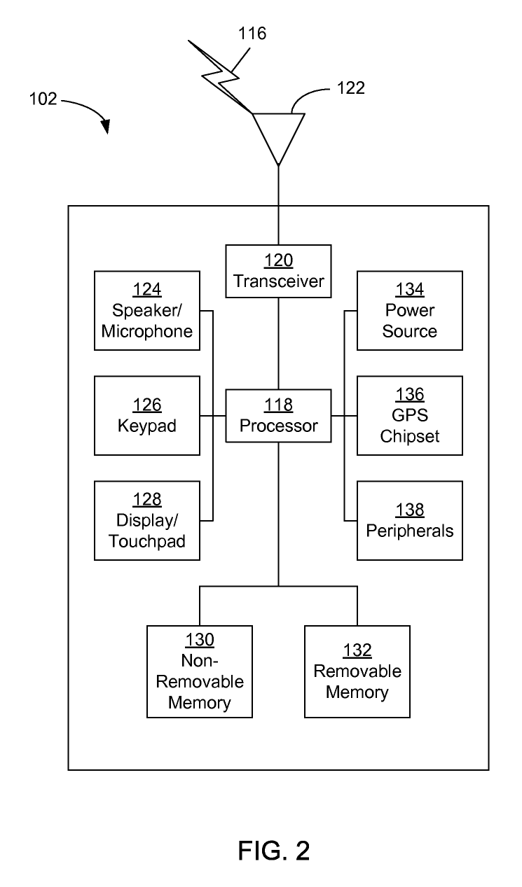

FIG. 2 is a system diagram of a representative WTRU 102. As shown in FIG. 2, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 2 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 2 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

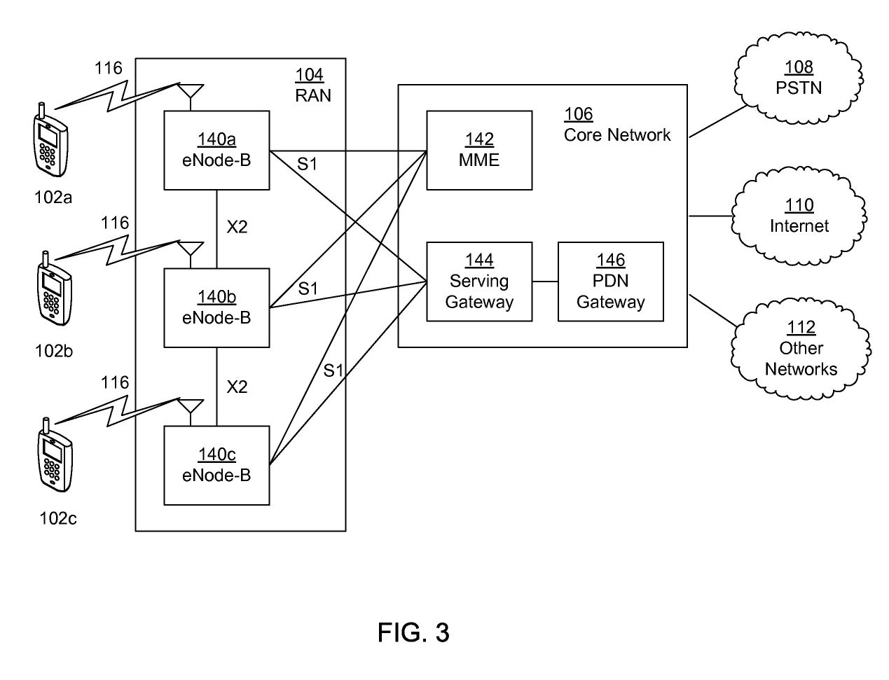

FIG. 3 is a system diagram of the RAN 104 and the core network 106 according to another embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 3, the eNode-Bs 140a, 140b, 140c may communicate with one another over an X2 interface.

The core network 106 shown in FIG. 3 may include a mobility management gateway (MME) 142, a serving gateway (SGW) 144, and a packet data network (PDN) gateway (or PGW) 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

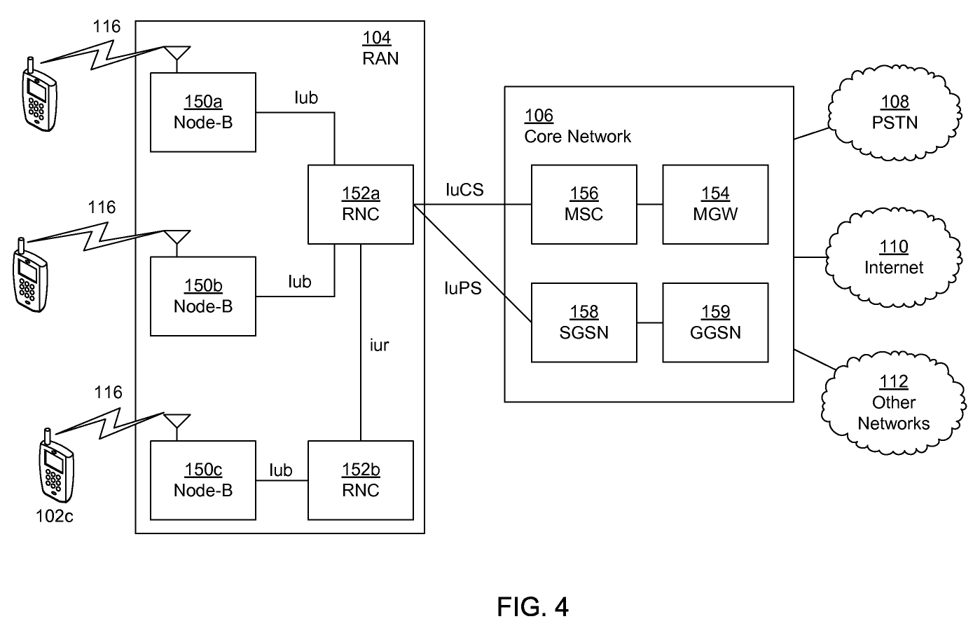

FIG. 4 is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 3, the RAN 104 may include Node-Bs 150a, 150b, 150c, which may each include one or more transceivers for communicating with the WTRUs 102a, 102b, 102c over the air interface 116. The Node-Bs 150a, 150b, 150c may each be associated with a particular cell (not shown) within the RAN 104. The RAN 104 may also include RNCs 152a, 152b. It will be appreciated that the RAN 104 may include any number of Node-Bs and RNCs while remaining consistent with an embodiment.

As shown in FIG. 4, the Node-Bs 150a, 150b may be in communication with the RNC 152a. Additionally, the Node-B 150c may be in communication with the RNC 152b. The Node-Bs 150a, 150b, 150c may communicate with the respective RNCs 152a, 152b via an Iub interface. The RNCs 152a, 152b may be in communication with one another via an Iur interface. Each of the RNCs 152a, 152b may be configured to control the respective Node-Bs 150a, 150b, 150c to which it is connected. In addition, each of the RNCs 152a, 152b may be configured to carry out or support other functionality, such as outer loop power control, load control, admission control, packet scheduling, handover control, macrodiversity, security functions, data encryption, and the like.

The core network 106 shown in FIG. 4 may include a media gateway (MGW) 154, a mobile switching center (MSC) 156, a serving GPRS support node (SGSN) 158, and/or a gateway GPRS support node (GGSN) 159. While each of the foregoing elements are depicted as part of the core network 106, it will be appreciated that any one of these elements may be owned and/or operated by an entity other than the core network operator.

The RNC 152a in the RAN 104 may be connected to the MSC 156 in the core network 106 via an IuCS interface. The MSC 156 may be connected to the MGW 154. The MSC 156 and the MGW 154 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 158 in the core network 106 via an IuPS interface. The SGSN 158 may be connected to the GGSN 159. The SGSN 158 and the GGSN 159 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

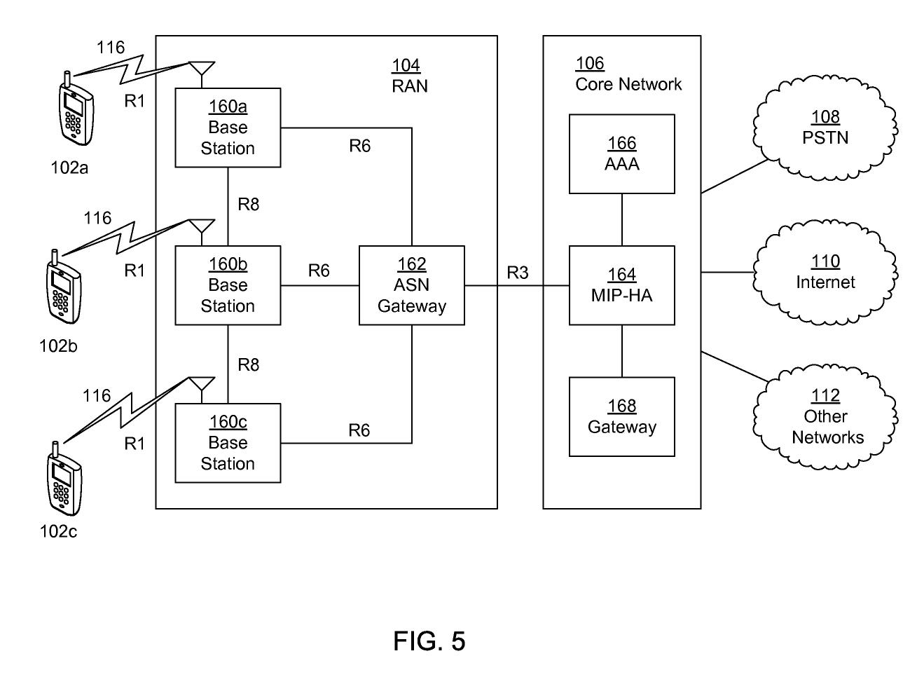

FIG. 5 is a system diagram of the RAN 104 and the core network 106 according to another embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 5, the RAN 104 may include base stations 160a, 160b, 160c, and an ASN gateway 162, though it will be appreciated that the RAN 104 may include any number of base stations and ASN gateways while remaining consistent with an embodiment. The base stations 160a, 160b, 160c may each be associated with a particular cell (not shown) in the RAN 104 and may each include one or more transceivers for communicating with the WTRUs 102a, 102b, 102c over the air interface 116. In one embodiment, the base stations 160a, 160b, 160c may implement MIMO technology. Thus, the base station 160a, for example, may use multiple antennas to transmit wireless signals to, and receive wireless signals from, the WTRU 102a. The base stations 160a, 160b, 160c may also provide mobility management functions, such as handoff triggering, tunnel establishment, radio resource management, traffic classification, quality of service (QoS) policy enforcement, and the like. The ASN gateway 162 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 160a, 160b, 160c may be defined as an R8 reference point that includes protocols for facilitating WTRU handovers and the transfer of data between base stations. The communication link between the base stations 160a, 160b, 160c and the ASN gateway 162 may be defined as an R6 reference point. The R6 reference point may include protocols for facilitating mobility management based on mobility events associated with each of the WTRUs 102a, 102b, 102c.

As shown in FIG. 5, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 164, an authentication, authorization, accounting (AAA) server 166, and a gateway 168. While each of the foregoing elements are depicted as part of the core network 106, it will be appreciated that any one of these elements may be owned and/or operated by an entity other than the core network operator.

The MIP-HA 164 may be responsible for IP address management, and may enable the WTRUs 102a, 102b, 102c to roam between different ASNs and/or different core networks. The MIP-HA 164 may provide the WTRUs 102a, 102b, 102c with access to packet-switched networks, such as the Internet 110, to facilitate communications between the WTRUs 102a, 102b, 102c and IP-enabled devices. The AAA server 166 may be responsible for user authentication and for supporting user services. The gateway 168 may facilitate interworking with other networks. For example, the gateway 168 may provide the WTRUs 102a, 102b, 102c with access to circuit-switched networks, such as the PSTN 108, to facilitate communications between the WTRUs 102a, 102b, 102c and traditional land-line communications devices. In addition, the gateway 168 may provide the WTRUs 102a, 102b, 102c with access to the networks 112, which may include other wired or wireless networks that are owned and/or operated by other service providers.

Although not shown in FIG. 5, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

A mobile user may choose from a wide range of technologies to access networks such as GPRS, EDGE, 3G and/or 4G for wide area access, and/or WiFi for local area access. Mobile hosts are increasingly becoming multi-homed (e.g., connected via multiple access technologies and/or multi-access points) and may possess two or more heterogeneous interfaces. Internet content is being increasingly distributed (e.g., over a “cloud”) such that content delivery is becoming more complex (e.g., to get the right content from the right location).

In certain representative embodiments, a multi-homed wireless device (e.g., a mobile host, mobile device, netbook and/or UE, among others) may access or receive (e.g., efficiently access or receive) content (e.g., internet-based content).

In certain representative embodiments, a multi-homed mobile host may use (e.g., may fully utilize) a subset or all of the available interfaces (e.g., wireless and/or wired) to send content or to receive content (e.g., efficiently receive content).

Although the receiver is described in FIGS. 1-5 as a wireless terminal, it is contemplated that in certain representative embodiments that such a terminal may use wired communication interfaces with the communication network.

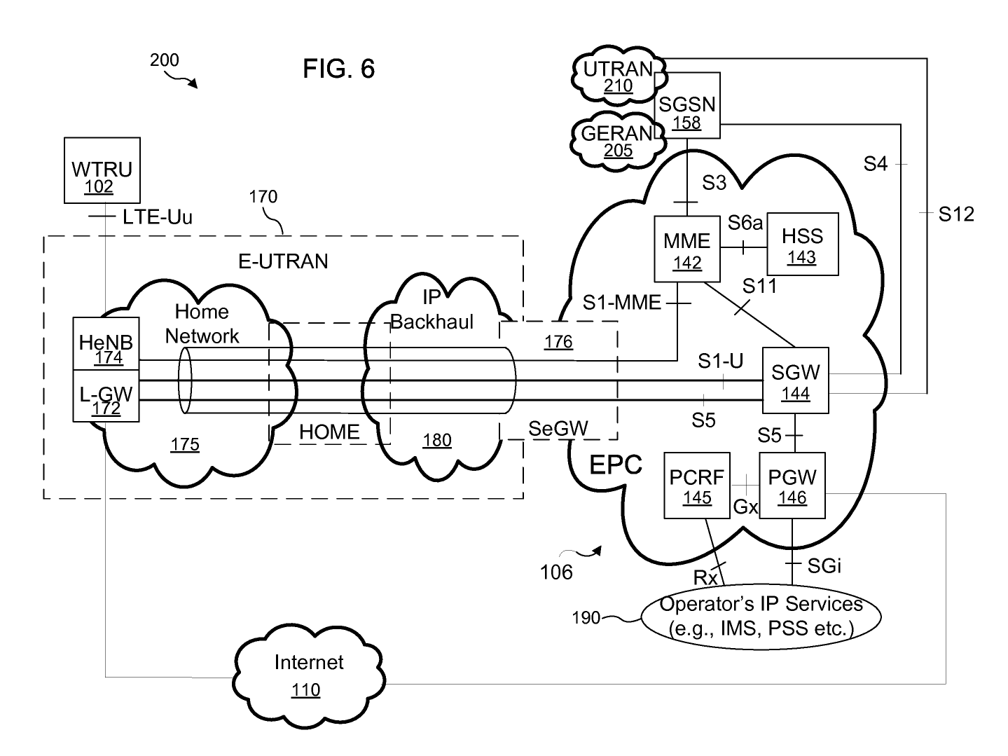

FIG. 6 is a diagram illustrating a representative architecture (e.g., for third generation partnership project (3GPP) accesses) including a local gateway (LGW) located on (e.g., physically on) a home evolved Node-B (HeNB).

Referring now to FIG. 6, the representative architecture 200 may include a CN 106, a security gateway (SeGW) 176 and a EUTRA network (E-UTRAN) 170. The CN 106 may include an MME 142, a SGW 144, a PGW 146, a Home Subscriber Server (HSS) 143, and/or a Policy and Charging Rule Function (PCRF) 145. The E-UTRAN 170 may include: (1) a home network 175 with a local gateway (LGW) 172 and/or a HeNB 174; and/or (2) an IP backhaul 180, and may interface with the evolved packet core of the CN 106 via the SeGW 176. The IP backhaul 180 may interface with the home network 170 via a Home GW 185.

The MME 142 may interface with: (1) the HSS 143 via an S6a interface; (2) the SGW 144 via an S11 interface; (3) the HeNB 174 of a home network 170 via the S1-MME interface; and/or (4) the SGSN 158 via the S3 interface. The SGW 144 may interface with: (1) the HeNB 174 via an S1-U interface and may connect (e.g., provide an interface (e.g., the S5 interface)) between the PGW 146 and the LGW 172; (2) the MME 142 via an S11 interface; (3) the SGSN 158 via the S4 interface; and/or (4) the UTRAN via the S12 interface. The PGW 146 may interface with: (1) the Operator's IP services 190 via a SGi interface; (2) the LGW 172 via the S5 interface using the SGW 144 and/or the PCRF 145 via the Gx interface. The HeNB 174 may interface with the WTRU 102 via an LTE-Uu interface.

Local Internet Protocol (IP) Access (LIPA) may provide a wireless transmit/receive unit (WTRU) 102 with an IP connection via the HeNB 174 over its radio access (e.g., LTE-Uu). The WTRU 102 may participate in an IP session with other IP entities in the same residential/enterprise IP network that is local relative to the WTRU's HeNB location. The data traffic for the LIPA may not traverse the operator's CN 106. The signaling traffic may traverse the CN 106 (e.g., the signaling for LIPA traffic, for example, may terminate at the MME 142).

Without the LIPA, the IP address of the WTRU 102 may be allocated by a PGW 146, which may reside in the CN 106. Without the LIPA, the traffic path in the uplink (UL) may be from the WTRU 106, to an eNB in the E-UTRAN 170, to the SGW 144, to the PGW 146 and then to the operator's IP network 190. For the downlink (DL), the data path may be reversed, (e.g., from the PGW 146, via SGW 144, via the eNB (or HeNB) in the E-UTRAN 170 and to the WTRU 102).

The LIPA may allow the WTRU 102 to establish an IP connection with a local network, such as the network of a university campus. It is contemplated that the WTRU 102 may have two or more packet data network (PDN) connections including at least one PDN connection to the CN 106 and at least one other PDN connection to the local network, e.g., the LIPA. In another example, a user may have an IP network at the home of the user to which many devices are connected, e.g., printers, television (TV), audio players, and the like. The WTRU 102 may have a local connection to the IP network, e.g., LIPA.

For the LIPA connections, the LGW 172 may be used, (which may be equivalent to the PGW 146), that is collocated (e.g., physically co-located) on the HeNB 174 or closed subscriber group (CSG).

The WTRU 102 with a LIPA PDN connection may request a circuit switched fallback (CSFB) service, e.g., to start a mobile originated (MO) call or to accept a mobile terminated (MT) call. Since CSFB may involve a change of the radio access technology (RAT) (e.g., inter-system change, for example, from LTE to GERAN or UTRAN (e.g., global system for mobile communications (GSM)/enhanced data rates for GSM evolution (EDGE) radio access network (GERAN) or universal terrestrial radio access network (UTRAN)), the WTRU 102 may leave its HeNB 174. The target network may not support packet switched (PS) handover (HO), and PS services that the WTRU 102 had in LTE may be suspended. It is contemplated that the suspended traffic, if any, may be CN traffic.

In certain representative embodiments, the LIPA may be maintained even after CSFB services may be initiated (e.g., the WTRU 102 may leave its current HeNB 174 (e.g., in case of LIPA) and/or may change the RAT). In certain representative embodiments, the WTRU 102 may have only the LIPA PDN connection switched, and may have one or more other PDN connection for CN traffic.

In certain representative embodiments, common representative principles/operations may apply to both representative UMTS systems and representative evolved packet systems (EPSs) and may include one or more of:

(1) separate packet data network (PDN) connection or connections for traffic going through the mobile operator's (MO's) CN 106;

(2) pre-release 9 3GPP standard WTRUs 102 that support Multiple PDN connections may simultaneously access LIPA, selective IP traffic offloading (SIPTO) and/or MO's CN PDN connections, among others;

(3) for LIPA traffic a Local P-GW function or Local GGSN function for EPS and UMTS, respectively, may be located within, for example, a residential/enterprise network;

(4) for traffic going through the MO's CN 106, the P-GW/GGSN 146 and 159 may be located within the CN 106;

(5) the LIPA PDN may be identified by an access point name (APN) (e.g., a well-defined name);

(6) mobility management signaling between the WTRU 102 and network may be handled in the CN 106;

(7) session management signaling (bearer setup, etc.) may terminate in the CN 106.

(8) before a LIPA or SIPTO PDN connection is established, the WTRU 102 may be authenticated, authorized and/or registered by the CN 106.

(9) the paging function for the LIPA/SIPTO traffic may be located in the Core SGSN/MME 158 and 142.

(10) for active WTRU's 102, mechanisms to optimize the routing of the EPS/UMTS bearers used for LIPA traffic may be implemented that allow the user plane to bypass the Core SGW 144 and/or SGSN 158.

(11) representative procedures for the PDP context/PDN connectivity activation may be used to: (a) establish the LIPA; (b) determine if the LIPA is enabled/disabled for the WTRU 102; (c) perform LGW selection at the SGSN/MME 158 and 142; and/or (d) provide correlation information to enable the direct path between the H(e)NB 174 and the LGW 172.

(12) representative procedures for the PDP context/PDN connectivity deactivation may be used to deactivate the LIPA PDP context/PDN connectivity.

Based on the above representative principles/operations, a separate PDN connection may be established for traffic going through the MO's CN 106. The WTRU 102 may have one PDN connection for LIPA and one or more other PDN connections for CN traffic.

It is contemplated that a LIPA connection may be available (e.g., only available) when a WTRU 102 is covered by (e.g., under the coverage of) a HeNB 174 (or the HNB in the case of 3G) that may provide the LIPA connection, for example, to the Internet 110 (e.g., without traversing the CN 106). If the WTRU 102 moves away from the HeNB's coverage (e.g., move out of the HeNB's coverage area), the PDN LIPA connection may be deactivated. For example, in LTE, if the WTRU 102 had (e.g., only had) a PDN connection for the LIPA and the connection is deactivated, the WTRU 102 may have to re-attach to the system (e.g., since the WTRU 102 is to have (e.g., to always have) a PDN connection (for example, which translates to an IP address acquisition in LTE).

If a TRACKING AREA UPDATE REQUEST message is received from the WTRU 102 having a LIPA PDN connection, and if the stored cell identity for the EPS bearer context of the LIPA PDN connection is different from the current cell identity, the MME 142 may deactivate (e.g., locally deactivate) the EPS bearer contexts (e.g., all of the EPS bearer contexts) associated with the LIPA PDN connection. If no active EPS bearer contexts remain for the WTRU 102, the MME 142 may send the TRACKING AREA UPDATE REJECT message that may include the EPS mobility management (EMM) cause value #10 (“implicitly detached”).

If a service request is received from the WTRU 102 having a LIPA PDN connection, and if the stored cell identity for the EPS bearer context of the LIPA PDN connection is different from the current cell identity, the MME 142 may deactivate (e.g., locally deactivate) the EPS bearer contexts (e.g., all of the EPS bearer contexts) associated with the LIPA PDN connection. If no active EPS bearer contexts remain for the WTRU 102, the MME 142 may send a SERVICE REJECT message including the EMM cause value #10 “implicitly detached”.

If the WTRU 102 moves out of coverage of the HeNB 174 that provided the LIPA, the Tracking Area Update (TAU) or Service Request (SR) of the WTRU 102 may be rejected, if the WTRU 102 had (e.g., only had) a LIPA PDN connection. The “implicitly detached” cause code that is received by the WTRU 102 may force the WTRU 102 to re-attach to the system. It is contemplated that the mobility of the WTRU 102 out of the HeNB coverage area may be performed in idle mode and the WTRU 102 may later send a TAU or SR message when, for example, the periodic TAU timer expires or for transitioning from idle mode to connected mode.

In certain representative embodiments, the WTRU 102 may be handed over to another cell, (e.g., mobility in the connected mode (e.g., handover) may occur from the HeNB 174 which may provide LIPA to another cell). It is contemplated that the LIPA bearers that pertain to a LIPA connection first may be released in the source HeNB 174 (or HNB in the case of 3G) before proceeding with the handover (HO) procedure. The source HeNB 174 may indicate the HO to the LGW 172 which may releases the LIPA bearers (e.g., all of the LIPA bearers) as per the PGW 146 initiated bearer deactivation procedure, and the HO may be executed by the source HeNB 174.

In certain representative cases, the circuit switched fallback (CSFB) procedure may be executed by releasing the RRC connection and redirecting the WTRU 102 to another domain/RAT (e.g., GERAN/UTRAN 205 and 210).

In certain representative embodiments, HO procedures may be implemented to provide CSFB functionality while maintaining an RRC connection (e.g., the HO of the WTRU 102 may occur while maintaining the connected mode for the WTRU 102 to the CN 106).

In certain representative embodiments, the LIPA bearers may not be deactivated during the initiation of CSFB to enable PS services and the LIPA PDN connection to resume after CSFB may be complete.

In certain representative embodiments, handling procedures may be implemented to handle Service Requests and/or Extended SR (ESR) from the WTRU 142 by the MME 142 such that proper resumption of LTE services after CSFB may be ensured.

In certain representative embodiments, handling procedures may be implemented to handle connected mode HOs of the WTRUs 102 that may move to another cell within the same tracking area/routing area/location area (TA/RA/LA) (for example, because the WTRU 102 may not be performing NAS signaling to be informed that it is implicitly detached).

In certain representative embodiments, handling procedures may be implemented to handle connected mode HO of the WTRU 102, when the WTRU 102 has (e.g., only has) a single LIPA PDN connection.

In certain representative embodiments, handling procedures may be implemented to handle the WTRU 102 on a closed subscriber group (CSG) cell with a LIPA connection, for example, when the WTRU's subscription has expired, and/or the WTRU is not allowed on the CSG.

In certain representative embodiments, handling procedures may be implemented to handle when the WTRU 102 moves from the CSG cell where LIPA had been provided and the WTRU may not have another PDN connection, for example, where the WTRU 102 may send a SR message to place an IMS emergency call.

For example, if the WTRU's NAS request (e.g., a SR) is rejected due to expiration of a CSG subscription, the cause code #25 “not authorized for this CSG” may be sent to the WTRU 102 and may cause the MME 142 confusion whether the CSG subscription expired or the WTRU 102 is not allowed in the CSG.

The EMM cause #25 (not authorized for this CSG) may be applicable (e.g., only applicable) when received from a CSG cell. If the SERVICE REJECT message with the EMM cause #25 was received without integrity protection, the WTRU 102 may discard the message.

The WTRU 102 may set the EPS update status to EU3 ROAMING NOT ALLOWED (and may store it). The WTRU 102 may enter the state EMM-REGISTERED.LIMITED-SERVICE.

If the CSG ID of the cell where the WTRU 102 has initiated the service request procedure is included in the Allowed CSG list, the WTRU 102 may remove the entry corresponding to this CSG ID from the Allowed CSG list. If the CSG ID of the cell where the WTRU 102 has initiated the service request procedure is included in the Operator CSG list, the WTRU 102 may apply the procedures defined, for example, in section 3.1A of 3GPP Technical Specification 23.122, V9.5.0, entitled “3rd Generation Partnership Project; Technical Specification Group Core Network and Terminals; Non-Access-Stratum (NAS) functions related to Mobile Station (MS) in idle mode (Release 9)” published December, 2011, the entire contents of TS 23.122 being incorporated by reference herein.

The WTRU 102 may search for a suitable cell in the same public land mobile network (PLMN), for example, according to 3GPP Technical Specification 36.304, V9.5.0, entitled “3rd Generation Partnership Project; Technical Specification Group Radio Access Network; Evolved Universal Terrestrial Radio Access (E-UTRA); User Equipment (UE) procedures in idle mode (Release 9)” the entire contents of TS 36.304 being incorporated by reference herein.

If A/Gb mode or Iu mode is supported by the WTRU 102, the WTRU 102 may handle the GPRS mobility management (GMM) parameters, the GMM state and/or the GPRS update status as specified (for example, in 3GPP TS 24.008, V10.1.0, entitled “3rd Generation Partnership Project; Technical Specification Group Core Network and Terminals; Mobile radio interface Layer 3 specification; Core network protocols; Stage 3 (Release 10)” (the entire contents of TS 24.008 being incorporated by reference herein)) when the service request procedure is rejected with the GMM cause with the same value. The WTRU 102 may search for another suitable cell and not return to this cell until the CSG ID is added to its lists of allowed CSG IDs.

In certain representative embodiments, handling procedures may be implemented to handle the WTRU 102 on a closed subscriber group (CSG) cell with a LIPA connection, for example, when the WTRU's having a LIPA PDN connection (e.g., the only LIPA PDN connection) performs an idle mode reselection that leads to a change in radio access technology.

In certain representative embodiments, handling procedures may be implemented if the WTRU 102 had a LIPA connection in UTRAN 210, as the LIPA connection may not be maintained since there is no LIPA mobility in 3GPP Release 10. For example, the MME 142 may be informed that an IP connection of the WTRU 102 is a LIPA connection so that the MME 142 may know to allow the WTRU 102 to have an IP address (e.g., different from that of the LIPA) so that a user may start placing PS sessions. The indication of whether an existing PDP context for the WTRU 102 is LIPA-based may be implemented in the messages transferred between the SGSN 158 and the MME 142. It is contemplated that the same procedures may be equally applicable to the other direction of mobility (e.g., from the LTE to the UTRAN in idle mode) and/or if the WTRU 102 changes MMEs 142, and the new MME 142 contacts the old MME 142 (or the WTRU 102 changes SGSN 158 and the new node contacts the old SGSN 158). The handling procedures provided for idle mode mobility from the UTRAN 210 to the LTE also apply for other RATs, as well.

In certain representative embodiments, the WTRU 102 may be in a HeNB coverage area and may have a LIPA PDN connection. The WTRU 102 may also have another PDN connection for the CN traffic. Although the term “PDN connection” is used for both LTE and 3G, it is not limited to LTE or 3G and may generally refer to a PDP context or PDP connection or similar session in GERAN/UTRAN or other similar system and representative CSFB procedures may be equally applicable in general to different RATs, for example LTE and/or GERAN/3 G.

In certain representative embodiments, suspension procedures may be implemented to handle when a LIPA PDN connection suspension occurs (e.g., when CSFB is performed). Even though the WTRU 102, when performing CSFB, may actually disconnect its radio from the source HeNB 174, the LIPA PDN connection may not be cancelled because of the CSFB. The WTRU 102 may return to the same cell (e.g., the HeNB 174 where the LIPA PDN connection was previously established to resume PS services) after the CS service is completed. When the WTRU 102 sends, for example, the ESR message for the CSFB to the MME 142, the MME 142 may know (e.g., determine) if there is a PDN connection established for the LIPA for the WTRU 102. The MME 142 may inform the LGW 172 (e.g., directly or indirectly inform) the LGW 172 about the CSFB and the LGW 172 may suspend the LIPA bearers for the WTRU 102 sending the ESR message. In certain representative embodiments, the MME 142 may inform the HeNB 174 that the LIPA bearers of the WTRU 102 may be suspended (e.g., in LTE), by providing a new indication or information element (IE) in SLAP messages that are exchanged between the MME 142 and the HeNB 174 (e.g., the MME 142 may provide this indication, for example, in the WTRUContextModificationRequest (for example, with a CSFB indicator and/or a WTRU identity)). The new IE may have a value indicating that the LIPA bearers may be or are to be suspended or deactivated. In certain representative embodiments, the MME 142 may choose to inform the HeNB 174 that the LIPA PDN connection may be or is to be suspended or deactivated, e.g., based on operator policy for the WTRU 102, or regardless of operator policy. Based on the indication received from the MME 142 (e.g., to suspend the LIPA bearers), the HeNB 174 may inform the LGW 172 to suspend the bearers due to the unavailability of the WTRU 102 from the CSFB or the HO. If the LGW 172 was actively forwarding data to the WTRU 102, the LGW 172 may start buffering the data of the WTRU 102 for the LIPA bearer suspension until the LIPA PDN session is resumed. In certain representative embodiments, the buffering may be performed in the HeNB 174. It is contemplated that if there are other bearers for the CN traffic, (e.g., the WTRU 102 has at least one other PDN connection), the bearer or bearers may be handed over as part of the CSFB, if PS HO is supported. During the PS HO, the LIPA bearer or bearers may remain suspended (e.g., in LTE).

In certain representative embodiments, the user's input may be requested to suspend or deactivate the LIPA bearers. The indication from the user may be sent to the HeNB 174 via RRC messaging or to the MME 142 via NAS messaging. The MME 142 and/or the HeNB 174 may act according to the indication received (e.g., if the user indicates a preference to deactivate the LIPA PDN connection), the MME/HeNB 142 and 174 (and eventually the LGW 172) may proceed to deactivate the LIPA PDN connection. The HeNB 174 if and/or when executing and inter-system change for the WTRU 102, for example, via a PS HO, may not include the LIPA bearers as part of the bearers to hand over to the GERAN/UTRAN 205 and 210.

If the LIPA PDN connection is suspended for the WTRU 102, the MME/HeNB (or eNB)/LGW 142, 174 and 172 may use a timer that may guard the duration of suspending the LIPA bearers. When the timer expires and the WTRU 102 has not returned (e.g., not yet returned) to the source/original HeNB 174 (e.g., in LTE), the LGW 172 may deactivate the LIPA PDN connection/bearers. The deactivation may be indicated to the HeNB 174 and to the MME 142 either by the LGW 172 or by the HeNB 174. The timer may be in the MME 142 (or HeNB 174) which may inform the LGW/HeNB 172 and 174 to deactivate the LIPA bearers upon the expiration of the timer. The WTRU 102 may receive the suspension command for the LIPA bearer with a similar suspension timer setting for the same behavior. The WTRU 102 may set a suspension flag for the LIPA and may buffer data (e.g., for the uplink) if useful for later resumption. If suspended, the WTRU 102 may not deactivate the LIPA bearers locally.

When the WTRU 102 is done with (e.g., completed) the CSFB or some type of temporary absence, if the WTRU 102 intends to resume the suspended LIPA access, once it enters the idle mode, it may reselect to its original HeNB 174 (or CSG cell), if the original HeNB 174 (or CSG cell) is still a suitable cell. If the network desires to resume the suspended LIPA access, the network may redirect the WTRU 102 to its original HeNB 174 (or CSG cell). The redirection may be performed by the 3G/UTRAN 210 or GERAN 205 system after the CS service is completed. For example, the SGSN 158 (or any other CN node, e.g., MSC 156/VLR (not shown)) may request the RAN 104 to perform redirection to the source HeNB 174. This request may be based on an indication sent from the WTRU 102 or the LTE network (e.g., the MME 142 or the HeNB 174) to the GERAN/3G network 205 and 210 (e.g., BSS, NB, HNB, SGSN, MSC/VLR, RNC).

When the WTRU 102 returns from the CSFB or some temporary absence to the source/original HeNB 174 (or the CSG cell), the suspended LIPA connection/traffic, if not yet deactivated, may be resumed with one or more of the following mechanisms.

The WTRU 102 may send an indicator indicating its intention to resume the suspended LIPA connection/traffic in occasions of the RRC Connection establishment or reestablishment messages and/or other UL RRC messages to the HeNB 174/CSG cell, and the HeNB 174 may forward/replicate, (e.g., send another message with similar intention), such an indication to the LGW 172 and/or the MME 142 (e.g., the MME 142 may request the LGW 172 to resume LIPA service) to resume the suspended bearers; or the EMM messages such as the SR, the TAU or other PDN Connection signaling messages to the network/MME 142 (e.g., the MME 142 may (e.g., in turn) use the message, information and/or signaling to send a message to: the HeNB 174, the LGW 172 or both to resume the LIPA service); or the LGW/HeNB 172 and 174 may indicate the presence of the suspended LIPA connection/traffic to the relevant WTRU 102 when the WTRU's returning to the CSG cell or HeNB 174 is detected.

If the WTRU 102 is in Idle mode, the LGW/HeNB 172 and 174 may invoke a CN paging or a RAN paging (e.g., in UMTS) to the relevant WTRU 102. If the WTRU 102 is connected or is in the process of connecting to the HeNB 174, the HeNB/LGW 174 and 172 may either perform an indication to the relevant WTRU 102 via a DL signaling message over the RRC or over the EMM or a given (e.g., special) LGW 172 to the WTRU messages; or the HeNB/LGW 174 and 172 may either trigger the MME 142 to resume the LIPA bearer previously suspended to the relevant WTRU 102 or the LGW/HeNB 172 and 174 may reconnect (e.g., just reconnect) the suspended LIPA bearer with the relevant WTRU 102.

The WTRU 102/user may ignore the suspended LIPA connection/traffic when the WTRU 102 returns from the CSFB or some temporary absence to the original HeNB 174 or the CSG cell and may remove the suspension flag or the buffered data.

The WTRU 102/user may reject or ignore the HeNB/LGW 174 and 172 indication for resuming the suspended LIPA connection and/or traffic. In that case, the HeNB/LGW 174 and 172 may remove the suspension flag and the buffered data and may notify the MME 142 of the deactivation status of the previously suspended LIPA bearer.

In certain representative embodiments, the MME 142 may not reject the ESR, if sent from a cell different from the HeNB 174 where a LIPA PDN connection was available for the WTRU 102. If the WTRU 102 with a LIPA PDN connection (e.g., with only a single LIPA PDN connection) moves out of the HeNB 174 (where the LIPA connection was provided) in idle mode, and sends an ESR to the MME 142 for the CSFB, the MME 142 may not reject the ESR (regardless of the service type that may be included in the ESR (e.g., the MO CSFB, or three MO Emergency calls, or Supplementary Services, etc) if (e.g., even if) the WTRU 102 has (e.g., only has) a PDN connection for the LIPA. The WTRU 102 may not re-attach first before performing the CSFB. The WTRU 102 may continue with the CSFB and the MME 142 may later request the WTRU 102 to re-attach to the network when the CS service is completed or when the WTRU 102 returns to LTE. The MME 142 may inform the MSC 156/VLR over the SGs interface that the WTRU 102 may be implicitly detached in LTE. Thus, the MSC 156/VLR may keep paging the WTRU 102 in the GERAN/UTRAN 205 and 210 and may not forward the paging requests to the MME 142 until the WTRU 102 completes its combined registration in LTE. The MSC156/VLR or SGSN 158 may indicate to the WTRU 102 that Idle Mode Signaling Reduction (ISR) is deactivated when the MME 142 informs the WTRU 102 about the implicit detach.

In certain representative embodiments, the WTRU 102 may choose to select or reselect to the CS domain, if the ESR is rejected with a cause indicating an implicit detach. The WTRU 102 may first proceed to place the CS service and later return to LTE and performs an attach.

In certain representative embodiments, handling procedures may be implemented for handling WTRU connected mode mobility with only a LIPA PDN connection. If the WTRU 102 has (e.g., only has) a PDN connection for the LIPA, (e.g., and no other PDN connections for the CN traffic), and the HeNB 174 is about to perform a connected mode WTRU HO, the source HeNB 174 may request the LGW 172 to deactivate/release the LIPA bearers for the WTRU 102. When the request to deactivate/release the LIPA bearers occurs, the WTRU 102 may have no other bearers to be handed over to deactivate/release the LIPA bearers for the WTRU 102.

If the source HeNB 174 determined or views that no more bearers exist for the WTRU 102 after the deactivation of the LIPA bearers in the LGW 172, the HeNB 174 may abort the HO procedure. The HeNB 174 may please (e.g., satisfy) the WTRU's RRC connection (e.g., by redirecting the WTRU 102 to another neighboring cell). When the WTRU 102 goes to (e.g., and/or attempts attachment at) another cell and sends a NAS message to the MME/SGSN 142 and 158 (e.g., an SR or a TAU), the WTRU's NAS message may be rejected and the WTRU 102 may be requested to re-attach (e.g., by sending a Service Reject or a TAU Reject with a cause indication of “implicit detach”. The WTRU 102 may be forced to go to idle mode and/or may be forced to send a NAS message for its next attempt to go to the connected mode. The WTRU's RRC connection may be released without any redirection information. In certain representative embodiments, a new RRC release cause may be introduced to inform the WTRU 102 to perform a re-attach to the network or to inform the WTRU 102 that the HO could not be continued due to lack of bearers and the WTRU 102 may then perform an attach procedure.

In certain representative embodiments, when the LGW 172 initiates the deactivation of the LIPA bearers for the WTRU 102 (e.g., which is sent towards the MME 142), if the MME 142 views and/or determines that there are no other non-LIPA bearers, the MME 142 may inform the HeNB 174 to proceed with the HO, for example, the MME 142 may inform the HeNB 174 to release the LIPA bearers and may perform SRB HO. This may be performed with the use of a new indication in the SLAP messages, (or RANAP messages in case of 3G or other equivalent messages for other systems). The HeNB 174 may indicate that there are no more non-LIPA bearers for the WTRU 102 by either the LGW 172 or the MME 142 or both. The MME 142 may request the WTRU 102 to re-activate a new PDN connection while still in the source cell, or optionally after the WTRU 102 moves to a target cell with or without having performed SRB only HO. It is contemplated that all the embodiments disclosed herein are equally applicable to inter-RAT HO procedures.

If a HeNB 174 is performing a HO due to the CSFB, the HeNB 174 may not wait for the LGW 172 to complete the deactivation of the LIPA bearers before the HeNB 174 starts executing the HO. The HeNB 174 may execute the HO before the LIPA bearers are deactivated and the HeNB 174 may inform the LGW 172 to suspend the LIPA bearers. In certain representative embodiments, while executing the HO or the CSFB, for example, the HeNB 174 may request the LGW 172 to deactivate the LIPA bearers. The deactivation of the LIPA bearers may be done, for example, after the CSFB so that no delays affect the CSFB procedure and/or so that if the HO is to be performed because of an IMS emergency call, it may be completed by a WTRU 102 without delays (e.g., immediately) due to the LIPA bearers being deactivated. For example, the HeNB 174 may not wait for the deactivation of the LIPA bearers before performing HO for the WTRU 102 that has an IMS emergency call (e.g., because waiting for deactivation of the bearers may cause a time delay and the WTRU 102 might lose its radio connection with the HeNB 174 and drop its calls (e.g., all its calls) including, for example, an emergency call if one exists). For the case where an IMS emergency call exists or when the CSFB is to be performed with PS HO, the MME 142, (if it is part of the HO signaling), may allow the HO to continue without rejecting or requesting further actions so that no delays are added. If the MME 142 requests the LIPA bearers to be released (or deactivated) by the appropriate nodes, for example, the SGW 144, the release or deactivation may be done in parallel with the PS HO or after the PS HO is completed so that delays (e.g., all delays) may be eliminated.

When requesting the LGW 172 to perform deactivation of the LIPA bearers, the HeNB 174 may include a reason for the deactivation (and similarly a reason for requesting a suspension). This reason for deactivation or suspension may be forwarded to the MME 142, (by the HeNB 174 or the LGW 172). When the MME 142 analyzes the received reason, the MME 142 may choose to continue with the HO without requesting the release of the LIPA bearers or may request the WTRU 102 to attach again (e.g., initiate an attachment or reattachment procedure). In certain representative embodiments, a request by the MME 142 may be used to deactivate the LIPA bearers (e.g., when the WTRU 102 has another PDN connection). The MME 142 may choose to deactivate the LIPA bearers and request the WTRU 102 to re-attach in certain cases, for example, when the WTRU 102 does not have an IMS emergency call. If the WTRU 102 has an IMS emergency call or is requesting CSFB, the MME 142 may determine such a condition exists and may use the indication of the condition to delay certain procedures to provide for faster HO completion or to reduce delays, in general, during the CSFB and/or the HO.

In certain representative embodiments, the HeNB 174 may continue with the HO and may perform a HO of the signaling radio bearers (SRB) (e.g., only without any radio bearer HO). The HeNB 174 may indicate to the MME 142 that: (1) the HO may be for SRB (e.g., only SRB and not radio bearers); and/or (2) the reason for the HO (e.g., “no CN bearers available”). The indications may be as part of existing messages (e.g., the Handover Required message that may be sent over the S1AP interface in the case of a S1-based HO. The MME 142 may either accept or reject the HO based on operator policy or network configuration. If the MME 142 rejects the HO, the MME 142 may indicate the rejection to the source HeNB 174 which may release the RRC connection and redirect the WTRU 102 to another cell. If the MME 142 accepts the HO, the MME 142 may request the target cell to prepare the resources for the SRB HO (e.g., SRB only HO) and the MME 142 may include an indication to the target cell that the HO is a SRB HO (e.g., SRB HO only). After the completion of the HO, the MME 142 may inform the WTRU 102 to initiate a request for a PDN connection. This may be a new NAS message or the network may directly inform the WTRU to activate a default EPS (Evolved Packet System) bearer by sending the Activate Default EPS Bearer Context Request message (which is a NAS ESM message) and may include a new cause to indicate to the WTRU 102 that no current active PDN connection exists for the WTRU 102. The WTRU 102 and the network may follow typical or usual procedures after such a message is received by the WTRU 102. The network/MME 142 requesting the WTRU 102 to establish a new PDN connection may be performed in idle mode mobility (e.g., when the WTRU 102 moves out of the HeNB 174), and may later send a SR or TA Update (TAU) request message. Instead of rejecting the SR or TAU request (and informing the WTRU 102 that it is implicitly detached), the network may accept the TAU request and inform the WTRU 102 to establish a PDN connection. In certain representative embodiments, after completion of the HO, the MME 142 may inform the WTRU 102 to re-attach to the system (e.g., by sending a NAS Detach Request message with a detach type that has a value set to “re-attach required”).

In the case of an X2-based HO, the source HeNB 174 may inform the target that the HO is SRB (e.g., SRB only) based and may proceed as described herein for the case of the S1 HO. The target, after the completion of the HO, may inform the MME 142 about the SRB HO in the Path Switch Request message. The source HeNB 174 may inform the MME 142 about the SRB HO (e.g., SRB only HO) before its execution and may wait for the MME 142 to accept or reject the SRB HO.

In certain representative embodiments, new messages may be implemented or existing messages may include new information elements (IE) to provide for the SRB HO. For example, the new messages may be S1 based and/or the existing messages may be S1 based with a new IE. In certain representative embodiments, the HeNB 174 may continue with the HO and may perform a HO of the SRB only without any radio bearer HO. The source HeNB 174 may indicate to the WTRU 102 (for example, as part of the RRC reconfiguration message) that the HO is a SRB HO (e.g., SRB only handover). After a successful completion of the HO, the WTRU 102 may initiate a request for default PDN connection activation.

In certain representative embodiments, the HeNB 174 may continue with the HO and may perform a HO of the SRB only without any radio bearer HO. The WTRU 102 may detect that the HO is an SRB only HO (for example, autonomously based on content of the RRC reconfiguration message or based on an explicit indication from the HeNB 174) and may autonomously initiate a request for a default PDN connection.

For some or all of the representative embodiments described above, if the default PDN connection activation procedure fails, the WTRU 102 may autonomously initiate the release of the connection, (e.g., the release of the SRBs). In certain representative embodiments, the network (e.g., the MME 142) may initiate the release of the default SRBs.

In certain representative embodiments, the sole or only LIPA PDN connection/bearer may be modified prior to the HO. Before performing the HO of the WTRU 102, the LIPA attribute of the connection/bearer may be erased/disabled so that a normal HO may be performed to the WTRU 102 now with a normal non-LIPA connection. The WTRU 102 may preserve its assigned IP address and may not be detached by the network causing the WTRU 102 to be re-attached to the network again, which may enable service continuity (e.g., resumption of PS services and/or paging) and use less overall signaling overhead to the network.

The HeNB/LGW 174 and 172 may notify the MME 142 via a message or an indicator for either an explicit network initiated PDN connection/EPS bearer modification to modify the LIPA bearer to be a non-LIPA bearer and may include other connection details (for example, including the IP address and/or the MME 142) to implicitly de-LIPA the concerned PDN connection/bearer (e.g., by making/modifying the LIPA bearer into a normal bearer). The modification may apply to HOs that may be within the same MME 142 and/or the same PGW 146, among others. A similar indication may be sent to the WTRU 102, if the WTRU 102 also is to de-LIPA the concerned bearer. The HeNB/LGW 174 and 172 may remove the LIPA connection context and data from the concerned bearer and may start to perform a normal HO for the WTRU 102.

In certain representative embodiments, the HO may be disabled when the WTRU 102 has a LIPA PDN connection (e.g., only the LIPA PDN connection). Since the HO is to maintain service quality, a loss of the LIPA PDN connection (e.g., the only connection) from a HO may result in loss of the current service. In the case of a sole LIPA PDN connection, it may be useful to allow the WTRU 102 to stay on the HeNB 174 as long as it can maintain its radio link. The HO may be disabled on the WTRUs 102 having a sole LIPA PDN connection and that may use a radio link failure (RLF) procedure to monitor the radio link quality. The network may configure RLF parameters (e.g., specified or special RLF parameters) on the WTRUs 102 with sole LIPA PDN connections. When the RLF is triggered, the WTRU 102 may perform a RRC Connection Re-establishment procedure to restore the WTRU's services, or may perform TAU or re-attach if the RRC Connection Re-establishment procedure fails. It is contemplated that the procedures described above may be used in any combination whenever possible, and may also apply to the 3G case (e.g., when handing over a WTRU 102 with only one LIPA PDN connection from a 3G CSG cell).

In certain representative embodiments, handling procedures may be implemented for handling WTRU context when the CSG subscription expires and the WTRU 102 has (e.g., only has) an LIPA PDN connection. It is contemplated that the WTRU 102 may have only one LIPA PDN connection or the WTRU may have a LIPA PDN connection and at least another PDN connection for the CN traffic.

Where the WTRU 102 has only one LIPA PDN connection, if the WTRU's subscription has expired when the WTRU 102 tries to access the CSG cell, (e.g., it may send a SR or ESR or a TAU message), the network may reject the NAS message and may send an existing reject cause to the WTRU 102, for example “Not authorized for this CSG”. In one procedure, the WTRU 102 may search for a suitable cell. Since the WTRU's new cell may be different from the source HeNB 174 (or HNB in the case of 3G), the LIPA connection may not be available. If the WTRU 102 sends another NAS message from the target cell, the NAS message may be rejected again with a cause code indication “implicitly detach” and the WTRU 102 may have to re-attach to the system. The procedure may cause delays to services and/or negative impacts on user experience. Upon the receipt of the cause #25, the WTRU 102, which may know that there is an ongoing LIPA PDN connection (e.g., based on the well known APN that is used for LIPA), may search for a suitable cell and, in addition, deactivate its LIPA PDN connection (e.g., the related bearers (for example, all bearers)) locally without signaling to the MME 142 (or SGSN 158 in the case of 3G). The WTRU 102 may directly start with the attach procedure, if its PDN connections (e.g., all its PDN connections) have been deactivated locally. In certain representative embodiments, the WTRU 102 may request a new PDN connection without performing an attach procedure and may resume in the system after the PDN connection has been established. It is contemplated that such embodiments apply to other RATs including, for example, LTE and/or 3G.

In certain representative embodiments, a new cause code may be implemented to inform the WTRU 102 that is it not allowed on the CSG cell and, in addition, that it is implicitly detached. The WTRU 102 may search for a suitable cell and may initiate the attach procedure. The new cause code may reduce delays, since the WTRU 102 may, otherwise, eventually be rejected again in the suitable cell if it only had a PDN connection for the LIPA.

For the case where the WTRU 102 has a LIPA PDN connection and at least one other PDN connection for the CN traffic exists, if the WTRU 102 receives cause #25, in addition to searching for a suitable cell, the WTRU 102 may deactivate locally its bearers that are associated to the LIPA PDN connection without signaling to the MME 142 (or SGSN 158). The WTRU 102 may maintain the bearers associated to the CN PDN connection.

In certain representative embodiments, handling procedures may be provided for handling an IMS Emergency Call and the LIPA connection. It is contemplated that the WTRU 102 may desire to place the IMS emergency call while it has a LIPA PDN connection (e.g., during the LIPA PDN connection). The WTRU 102 may no longer reside (e.g., be in) the CSG cell where the LIPA connection was available. The WTRU 102 may send a NAS message from a cell different from where LIPA PDN connection was provided, and if the WTRU 102 only has one PDN connection for the LIPA, it may be informed that it is implicitly detached. The WTRU 102 may re-attach. If the WTRU 102 desires to place an emergency call, it is disadvantageous to reject the WTRU 102 and force it to re-attach since the request is for an emergency call. In this case, the network, (e.g., the MME 142, the SGSN 158 or any other CN node), may not reject the WTRU 102 because the LIPA connection may not be maintained. The network may instead accept the WTRU's request for the emergency call (e.g., may allow the appropriate signaling to go through as per usual emergency call request procedures) and may deactivate the WTRU's bearers that are related to the LIPA after (or during) the setup of resources (NAS, e.g., activation, EPS bearer contexts or access stratum, e.g., radio resources) for emergency bearers by, for example, sending a NAS ESM request to deactivate the PDN connection that is related to the LIPA. A new (or alternatively an existing) cause code may be used to inform the WTRU 102 that the reason for deactivation is that there is no LIPA in the current WTRU cell. The new (or existing) cause code may indicate to the WTRU 102 that a new PDN connection is to be established for non-emergency purposes. For example, the MME 142 may send the Deactivate EPS Bearer Context Request message to the WTRU 102 to deactivate the LIPA PDN connection with a new cause code. It is contemplated that the same embodiments apply to other systems (e.g., 3G that use equivalent messages for the same or similar purposes).

If the WTRU 102 sends a SR, (or ESR for packet services), for placing an emergency call, (e.g., the RRC establishment cause may be set to emergency call), and the WTRU 102 has one PDN connection for the LIPA, the network may not establish the user plane, if the WTRU 102 is not in the coverage of the HeNB/HNB (subsystem) that connects to the LGW 172. The WTRU 102 may locally deregister (detach) since no bearers have been established, and an attach may be completed again. To avoid delay due to local deregistration and re-attach by the WTRU 102, the WTRU 102 may remain in the system even if no user plane is established and may continue with the emergency call. The WTRU 102 may initiate the request for a PDN connection for an emergency call. For example, in this case (and hence differentiated from other cases), the WTRU 102 may make use of the establishment cause being set to emergency, as a special case of the SR procedure, even if no user plane is setup in response. If the establishment cause is set to an emergency call and the user plane is not established, the WTRU 102 may not perform local detach (deregistration) and a subsequent attach and may instead remain in the system and follow up with the appropriate signaling for emergency calls of any form, (e.g., including IMS and/or CSFB, and the like). It is contemplated that this may apply regardless of the reason why the network may not have set up the user plane. For example, it may be due to an error in the network, due to a lack of LIPA service continuity as explained above, and/or due to a local failure in the WTRU 102. For example, at the RRC level, the RRC layer may indicate the failure to the NAS/upper layers. The WTRU 102 may consider the establishment of SRBs as a successful termination of the service request procedure and may stop any related timer (e.g., T3417). In certain representative embodiments, the network may send another NAS message (e.g., a new NAS message such as a Service Accept or an existing NAS message, such as an EMM information with a specific cause value to indicate that the service request procedure has successfully terminated. The WTRU 102 may use the indication to determine (or conclude) that the procedure was successful and may stop any related timer.

In certain representative embodiments, the network may setup radio bearers for the LIPA PDN connection or any other EPS bearer that the network may have decided to not setup, even if no actual user data is to be exchanged. The MME 142 may indicate to the base station to include indications in the RRC pointing out that these bearers are “mock” bearers, and may not be used for user plane data. In certain representative embodiments, the WTRU 102 may not wait for termination of the service request procedure and may send (e.g., directly send) a PDN connectivity request for emergency bearer services. The response to the PDN connectivity request for emergency bearer services (or the response to any other message that was sent for emergency call of any form) may be determined (or considered) by the WTRU 102 as a successful termination of both the service request and the PDN connectivity request procedure. The WTRU 102 may determine or consider itself to be emergency attached. The WTRU 102 may establish a PDN connection to be the default non-emergency PDN connection, which may be done during the lifetime of the current emergency session of the WTRU 102, (or during the lifetime of the PDN connection for emergency bearer service). If the WTRU 102 is successful at establishing the PDN connection, the WTRU 102 may determine itself to be in normal service mode (e.g., not emergency attached or in a limited service mode).

In certain representative embodiments, the WTRU 102 may not consider itself emergency attached and may initiate a PDN connection for non-emergency purposes: (1) during the emergency call; (2) after a deactivation of the LIPA PDN connection, and/or (3) after the termination of the emergency call, among others. The initiation of the PDN connection may be autonomous or based on the received cause code in the request to deactivate the PDN connection for the LIPA. To differentiate this case from other cases where a PDN connection for emergency bearer service is allowed and the network considers the WTRU 102 emergency attached, (e.g., by deactivating non-emergency bearers, for example all non-emergency bearers, as a result of which even the WTRU 102 considers itself emergency attached), a new cause code that is used to deactivate the LIPA PDN connection may indicate that the WTRU 102 is not emergency attached. In certain representative embodiments, the network may send this indication, (e.g., the WTRU 102 is not emergency attached) to the WTRU 102 explicitly via a NAS or a RRC message.

In certain representative embodiments, handling procedures may be implemented for handling Idle Mode reselections when a LIPA connection exists. It is contemplated that a WTRU 102 may move, in idle mode, from UTRAN (3G) to LTE. The same may be applicable to mobility in idle mode (and connected mode if appropriate) from LTE to GERAN/UTRAN 205 and 210, or intra-LTE, intra-3G, and/or intra-GERAN mobility with changes of certain nodes such as the MME 142 or SGSN 158 (e.g., mobility that causes change in MME 142 within LTE or SGSN 158 within 3G).

If a WTRU 102 moves in idle mode from 3G to LTE and performs the TAU, the MME 142 may contact the SGSN 158 (e.g., by using the context request message to retrieve the WTRU's context). The SGSN 158 may respond with a context response message. The SGSN 158 may inform the MME 142 whether or not the WTRU 102 has a LIPA PDN connection in addition to the usual information that is sent to the MME 142. This information (e.g., may be included in the PDP Context IE or it may be defined as a new IE to be included in the message which is sent to the MME 142. The SGSN 158 may include other information that are related to LIPA (e.g., the cell ID (or similar ID, e.g., CSG ID) of the cell where the LIPA connection was provided. It is contemplated that the WTRU 102 may or may not have another PDN connection for the CN traffic.

In certain representative embodiments, the LIPA bearers and associated information, for example, IP address may not be included in the message to the MME 142. The MME 142 may determine that the WTRU 102 did not have any IP address in the source system. The MME 142 may take further actions as appropriate, for example, requesting the WTRU 102 to re-attach if no other PDN connection was available for the WTRU 102 in the source system. The source node (e.g., the SGSN 158) may exclude the LIPA related information, (e.g., bearers and/or IP address, among others), when it updates the target node (e.g., the MME 142) with the WTRU's context. The exclusion may occur regardless of whether the WTRU 102 has another PDN connection for the CN traffic. It is contemplated that the idle mode mobility may apply for connected mode mobility whenever possible.

Upon receipt of the information by the MME 142, a comparison may be made with the IE that is sent by the WTRU 102 in the TAU (e.g., the EPS bearer context status IE that may indicate the EPS bearers that are active in the WTRU 102). The MME 142, if LIPA mobility is not supported, may deactivate the LIPA associated bearers and related IP addresses locally (e.g., all of the LIPA associated bearers and related IP address) in accordance with (or as per) the indication from the SGSN 158) (e.g., without signaling to the WTRU 102). The MME 142 may respond to the WTRU 102 by accepting the TAU if the WTRU 102 had another PDN connection (e.g., different from the LIPA connection) and may indicate to the WTRU 102 in the TAU Accept message the bearers that remain active for the WTRU 102 in accordance with (or as per) the EPS bearer context status IE.

If the WTRU 102 does not have another PDN connection for the CN traffic (e.g., only has a LIPA PDN connection), the MME 142 may accept the TAU and request the WTRU 102 to perform a request for a PDN connection. A new cause in the TAU Accept message may be implemented to indicate to the WTRU 102 to perform the request for the PDN connection. In certain representative embodiments, the MME 142 may accept the TAU and indicate that there are no active EPS bearers for the WTRU 102 in the EPS bearer context status IE. The WTRU 102, based on this indication, may trigger the PDN connectivity request to acquire a new IP address. In other representative embodiments, the WTRU 102 may initiate an Attach procedure. In certain representative embodiments, the MME 142 may reject the WTRU's TAU and may indicate that the WTRU 102 is implicitly detached and the WTRU 102 may perform an attach procedure again.

It is contemplated that the messages described above, e.g., the context request and context response messages, are representative examples and that other equivalent or similar messages may be used, (e.g., if the SGSN 158 supports a certain version or release of the 3GPP specification, other messages may be used instead, (e.g., a SGSN context request and/or a SGSN context response).

If an inter-system change occurs in connected mode (e.g., during HO), the source system may indicate to the WTRU 102 whether or not the WTRU 102 may directly initiate the attach procedure after the HO, or it may initiate a TAU. The indication may depend on whether or not the WTRU 102 had (e.g., only had) a LIPA PDN connection. For example, if the WTRU 102 only had a PDN connection for the LIPA, the source system, (e.g., the HNB or the source NB, or the SGSN 158, etc), may inform the WTRU 102 to initiate an attachment, a TAU followed by a PDN connection request, or another appropriate procedure (e.g., as part of mobility message such as a HO command or the RRC connection release with redirection information) so that the WTRU 102 may not get rejected.

In certain representative embodiments, the WTRU 102 may be commanded or informed to perform a TAU (e.g., if the WTRU 102 has both a LIPA PDN connection and another PDN connection for the CN traffic).

The WTRU 102 may use its knowledge of whether or not it has multiple PDN connections, and/or if a PDN connection is a LIPA PDN connection, to determine whether to perform a TAU or attachment upon reselection or HO to an E-UTRAN 170 (e.g., in LTE) from a UTRAN 210 (or GERAN 205). For example, if the WTRU 102 performs an inter-system change to LTE, (e.g., a reselection in idle mode or a HO), the WTRU 102 may determine whether it had a PDN connection in the source system. If the WTRU 102 performs idle mode reselection or connected mode HO from the UTRAN 210 to E-UTRAN 170, or vice versa, the following may apply.

If there is no PDN connection or was no PDN connection in the source system, the WTRU 102 may initiate an attach procedure in LTE instead of the TAU.

If the WTRU 102 had at least one PDN connection in the source system, then for each PDN connection, the WTRU 102 may check if the PDN connection is for the LIPA or for the CN traffic. If the WTRU 102 has one PDN connection (e.g., only one PDN connection) and the WTRU 102 received (or has) an indication that the PDN connection is for LIPA, the WTRU 102: (1) may locally deactivate its LIPA PDN connection, associated bearers and/or PDP contexts; (2) may locally detach and/or (3) may initiate an attach procedure. If the WTRU 102 has more than one PDN connection and the PDN connections (e.g., all of the PDN connections) are LIPA PDN connections, the WTRU 102: (1) may locally deactivate its LIPA PDN connections, associated bearers and/or PDP contexts; (2) may locally detach and/or (3) may initiate the attach procedure. If the WTRU 102 has only one PDN connection and it has an indication that the PDN connection is not for LIPA, (or if no indication had been received that the PDN connection is for LIPA), the WTRU 102 may initiate the TAU procedure and may indicate the bearers that are active in the WTRU 102. If the WTRU 102 has multiple PDN connections, then the WTRU 102 may check whether it has at least one PDN connection that is not for LIPA. If the WTRU 102 has a PDN connection that is not for LIPA, the WTRU 102 may deactivate the LIPA PDN connection, may initiate the TAU procedure and may indicate to the MME 142 which bearers are active in the WTRU 102, (e.g., the WTRU 102 may not include any information related to the LIPA PDN connection bearers).

In certain representative embodiments, the WTRU 102 may initiate a TAU or an attach procedure in accordance with (or as per) operator policy or configurations that may be, for example, sent to the WTRU 102 via Open Mobile Alliance (OMA) device management (DM), over-the-air (OTA), and/or short message service (SMS), that may be preconfigured in the universal subscriber identity module (USIM) or the WTRU's non-volatile memory.

In certain representative embodiments, if the WTRU 102 is performing the CSFB from an E-UTRAN 170, (either by redirection or HO), the WTRU 102 may locally delete its LIPA PDN connection and/or the LIPA bearers when it goes to the target system. The WTRU 102 uses any knowledge or indication it has about whether a PDN connection is for LIPA. The WTRU 102 may be configured to delete (e.g., always locally delete) its LIPA PDN connection and/or the LIPA bearers when it moves (e.g., goes) to a target system, or suspend/maintain (e.g., always suspend or maintain) the LIPA bearers in accordance with a network indication or operator policy/configuration. If the WTRU 102 knows that the target CS cell to which it is moving/going is another HNB that is physically co-located with the HeNB 174, (e.g., LTE CSG cell), the WTRU 102 may maintain the LIPA bearers for possible return and resumption of the LIPA session.

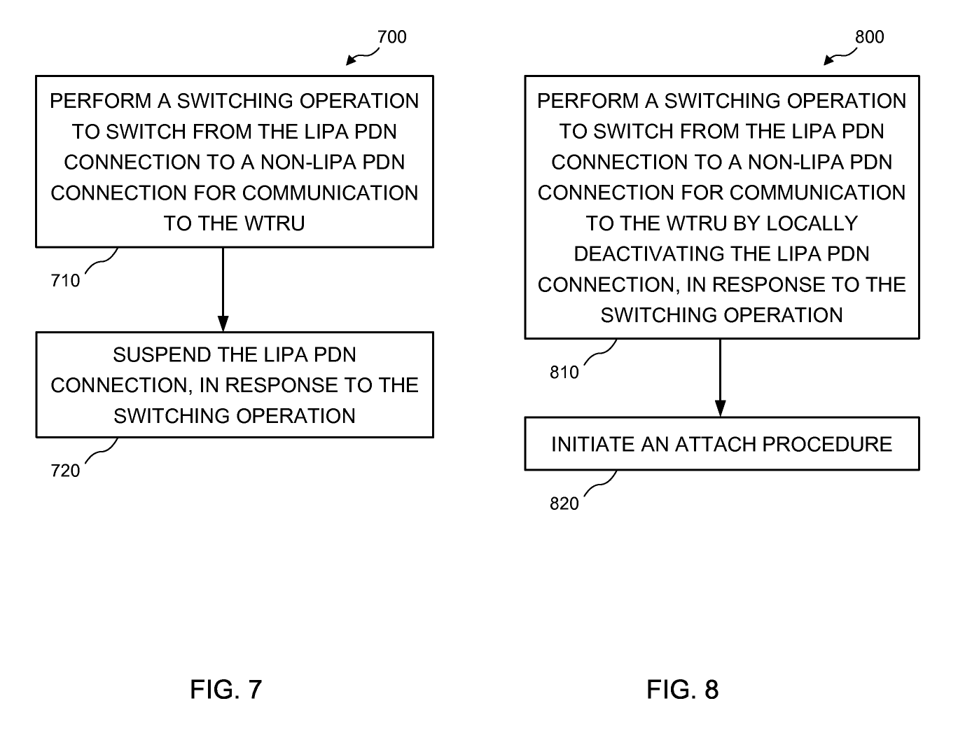

FIG. 7 is a flowchart illustrating a representative method for managing a Local Internet Protocol Access (LIPA) packet data network (PDN) connection.

Referring to FIG. 7, the representative method 700 may manage a LIPA PDN connection to a WTRU 102. At block 710, a switching operation (e.g., a CSFB operation) may be performed to switch from the LIPA PDN connection to a non-LIPA PDN connection (e.g., a 3G connection) for communication to the WTRU 102. For example, the WTRU 102 may desire to make a voice (or circuit switched (CS)) call or may desire to receive the voice (or the CS) call. The WTRU 102, for example, may initiate a service request (SR) to the MME 142 to initiate the CSFB operation. At block 720, the MME 142 may inform the LGW 172 of the CSFB operation and may initiate suspension of the LIPA PDN connection, in response to the switching operation (e.g., the CSFB operation). In certain representative embodiments, the MME 142 may control/manage the switching and suspension procedures. It is contemplated that any network entity may provide the control or management signaling/messaging to implement/initiate the switching procedures and suspension procedures including, for example, the MME 142, the eNB or the HeNB 172, the LGW 174 and/or the PGW 146.

In certain representative embodiments, The LGW 174 may resume the suspended LIPA PDN connection. The resumption of the LIPA PDN connection may be triggered after or in response to an end of the switching operation (e.g., after the voice or CS call is terminated). The resumption of the LIPA PDN connection may be automatic and may be initiated to enable the WTRU 102 to again be served by the LIPA PDN (e.g., or original radio access technology such as a LTE RAT). For example, the suspension of the LIPA PDN connection may include the LGW 174 suspending (e.g., without terminating) one or more LIPA bearers associated with the LIPA PDN connection such that the one or more LIPA bearers associated with the LIPA connection may resume operation, after execution of the switching operation (e.g., the CSFB operation).

In certain representative embodiments, one or more non-LIPA PDN connections (e.g., in a first domain associated with the local cell such as the LTE domain) may be established prior to the executing of the CSFB operation. For example, when one or more LIPA PDN connections to the WTRU 102 exists in the first domain associated with local cell (e.g., the LTE domain), movement of the WTRU out of the local cell during the CSFB operation may terminate the LIPA PDN connection of the WTRU 102 in the first domain. By adding a non-LIPA PDN connection in the first domain, it is contemplated that the context of the LIPA PDN connection may be maintained for later resumption of LIPA PDN connections to the WTRU 102 after the end of the CSFB operation.

In certain representative embodiments, the WTRU 102 or other network entity may determine whether a non-LIPA PDN connection in the first domain with the WTRU exists; and may selectively establish the non-LIPA PDN connection prior to the executing of the CSFB operation when the non-LIPA PDN connection in the first domain does not exist.

In certain representative embodiments, the switching operation may be initiated when the communication with the WTRU is of a first type (e.g., a voice call and/or a service having low bandwidth requirements, among others).

In certain representative embodiments, the switching operation may be halted when the communication with the WTRU is not of the first type or of one of more specified types (e.g., a streaming video, a high QoS required service and/or a service having high bandwidth requirements, among others). For example performance of the switching operation may include determining when the communication to be sent over the LIPA PDN connection is of the first type, and sending the first type of communication over the non-LIPA PDN connection and the resumption of the LIPA PDN connection may include determining when the first type of communication has ended, and sending a second type of communication, which is subsequent to the first type of communication, over the LIPA PDN connection. In certain representative embodiments, the non-LIPA connection may be in another type of RAT (e.g., a CSFB capable RAT) and/or another type of domain (e.g., a CS domain).

In certain representative embodiments, the suspension of the LIPA PDN connection may include determining whether any PDN connection with the WTRU is a non-LIPA PDN, and preventing deactivation of the LIPA PDN connection, for example, when one or more LIPA PDN connections (e.g., only LIPA PDN connections) exist with the WTRU 102 (e.g., based on the type of connections with the WTRU 102).

In certain representative embodiments, the deactivation or resumption of the LIPA PDN bearer (e.g., the LIPA connection) may be after a specified time period to allow the CSFB operation to end before either deactivation of resumption of the LIPA connection. For example, the LIPA may be suspended for a specified time after which if the WTRU 102 does not resume service on the local cell, the LIPA bearer (e.g., LIPA PDN connection) may be deactivated based on an expiration of a suspend timer. For example, a suspend timer may be initiated when the LIPA PDN connection is suspended such that during the suspend period the WTRU 102 may resume communication by unsuspending the suspended LIPA PDN connection and discontinuing the suspend timer. At the expiration of the suspend period, the LIPA PDN connection may be deactivated such that it may no long be unsuspended (e.g., any context information may be removed or erased such that resume of the LIPA PDN connection may not be possible).

In certain representative embodiments, the PDN associated with the non-LIPA PDN connection (for example used for the CSFB enabled service) may be informed of a pending service (e.g., a packet switched (PS) service such that a further switching operation may be performed to resume the suspended LIPA PDN connection to execute the pending service. For example, the further switching operation to resume the suspended LIPA PDN connection may be in response to an end of the CSFB operation.

In certain representative embodiments, CN nodes may indicate in messages exchanged for requesting a WTRU context whether a packet data protocol (PDP) or PDN connection is a LIPA connection.

FIG. 8 is a flowchart illustrating another representative method for managing a Local Internet Protocol Access (LIPA) packet data network (PDN) connection.

Referring to FIG. 8, the representative method 800 may manage a LIPA PDN connection to a WTRU 102. At block 810, a switching operation (e.g., a CSFB operation) may be performed to switch from the LIPA PDN connection to a non-LIPA PDN connection (e.g., a 3G connection) for communication to the WTRU 102. For example, the WTRU 102 may desire to make a circuit switched (CS) call or may desire to receive a CS or voice call. The WTRU 102, for example, may initiate a service request (SR) to the MME 142 to initiate the CSFB operation. In certain representative embodiments, the LIPA PDN may be locally deactivated in response to the switching operation to detach or disconnect the WTRU 102 from the LIPA cell. At block 820, the WTRU 102 may initiate an attach procedure to attach the WTRU 102 according to the service desired (e.g., for CSFB services the WTRU may attach to a CS enabled domain such as a 3G domain, a UTRAN domain and/or a GERAN domain, among others).

In certain representative embodiments, a tracking area update (TAU) procedure may be initiated responsive to the WTRU 102 having a PDN connection that is not for LIPA; and which bearers are active in the WTRU 102 may be indicated to the MME 1542 using enhanced signaling.

In certain representative embodiments, when a closed subscriber group (CSG) subscription expiry is detected, the LIPA PDN connection may be locally deactivated.

In certain representative embodiments, a received IP multimedia subsystem (IMS) emergency call from the WTRU 102 may not be rejecting, by a first cell, responsive to the first cell not being a cell in which the LIPA PDN connection had been provided.

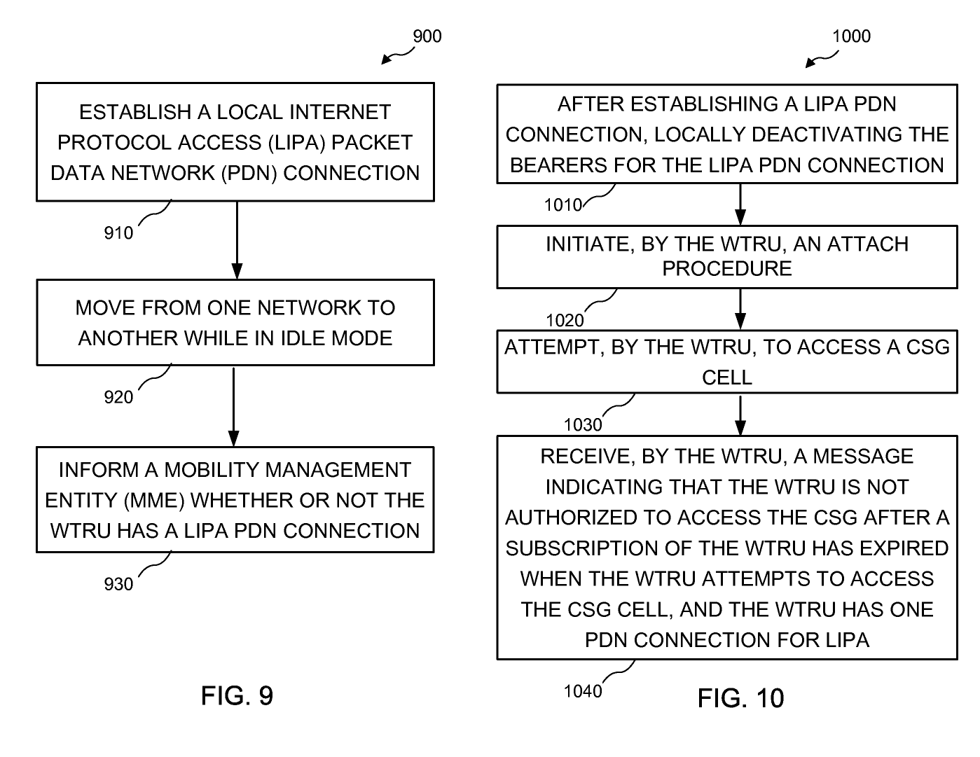

FIG. 9 is a flowchart illustrating a representative method for handling reselections by a WTRU.

Referring to FIG. 9, the representative method 900 may handle idle mode reselection by the WTRU 102. At block 910, an LIPA PDN connection may be established. At block 920, the WTRU 102 may move from one network (e.g., PDN) to another PDN while in idle mode. At block 930, the MME 142 may be informed of the status of the WTRU 102 (e.g., whether or not the WTRU 102 has a LIPA PDN connection). For example the WTRU 102 may send signaling or a message to the MME 142 including an information element (IE) that may indicate whether evolved packet system (EPS) bearers are active in the WTRU 102. This may enable the MME 142 to control reattachment and/or redirection procedures for the WTRU 102 to reduce or eliminate delay time associated with, for example, unwarranted or unneeded efforts to reattach to the LIPA PDN connection after movement to another PDN.

FIG. 10 is a flowchart illustrating a representative method for managing a WTRU context.

Referring to FIG. 10, the representative method 1000 may manage a context when a CSG subscription expires. At block 1010, after establishing a LIPA PDN connection, the bearers for the LIPA PDN may be locally deactivated (based on reception of cause #25 or a new cause code). At block 1020, the WTRU 102 may take the initiative to perform an attach. At block 1030, the WTRU 2102 may attempt to access a CSG cell. At block 1040, the WTRU 102 may receive a message indicating that the WTRU 102 is not authorized to access the CSG after a subscription of the WTRU has expired when the WTRU attempts to access the CSG cell, and the WTRU has one PDN connection for LIPA. For example, the bearers of the WTRU 102 that are associated with the LIPA PDN connection may be locally deactivated without signaling to or providing messages to the MME 142.

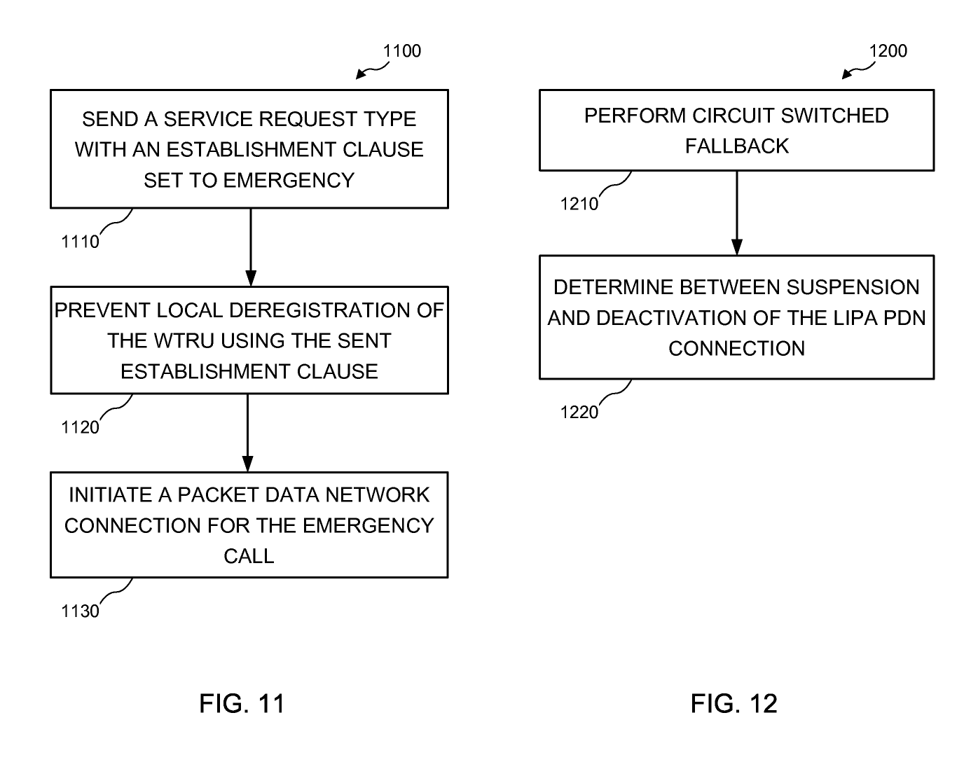

FIG. 11 is a flowchart illustrating a representative method for placing an emergency call.

Referring to FIG. 11, the representative method 1100 may place the emergency call from the WTRU 102. At block 1110, the WTRU 102 may send a SR type with information that may be sent in an establishment clause (e.g., which may be set to emergency). At block 1120, the MME 142 (and/or the LGW 174) may prevent local deregistration of the WTRU 102 using information sent in the establishment clause. At block 1130, a PDN connection may be initiated for the emergency call.

In certain representative embodiments, the WTRU 102 may make use of the establishment cause being set to emergency as a special successful case of the SR procedure even if the establishment cause is set to emergency call and the user plane is not established such that the WTRU may not perform local detach (deregistration) and a subsequent attach and may instead remain in the system and follow up with the signaling for the emergency call of any form (e.g., IMS or CSFB, among others). The WTRU 102 may consider the establishment of signaling radio bearers as a successful termination of the SR procedure and may stop any related timer.

In certain representative embodiments, the network may send another NAS message (e.g., a new NAS message such as a Service Accept or an existing NAS message (e.g., an EMM information with a specific cause value to indicate that the service request procedure is successfully terminated. The WTRU 102 may use this indication to conclude that the procedure was successful and stop any related timer.

In other representative embodiments, the network may setup the radio bearers for the LIPA PDN connection or any other EPS bearer that the network may have decided to not setup, even if no actual user data is to be exchanged. The MME 142 may indicate to the eNB 140 to include indications in the RRC pointing out that these bearers are “mock” bearers and may not be used for user plane data.

FIG. 12 is a flowchart illustrating a representative method for handling a LIPA PDN connection.

Referring to FIG. 12, the representative method 1200 for handling a LIPA PDN connection may include at block 1210, performing a circuit switched fallback and, at block 1220, determining between suspension and deactivation of the LIPA PDN connection.

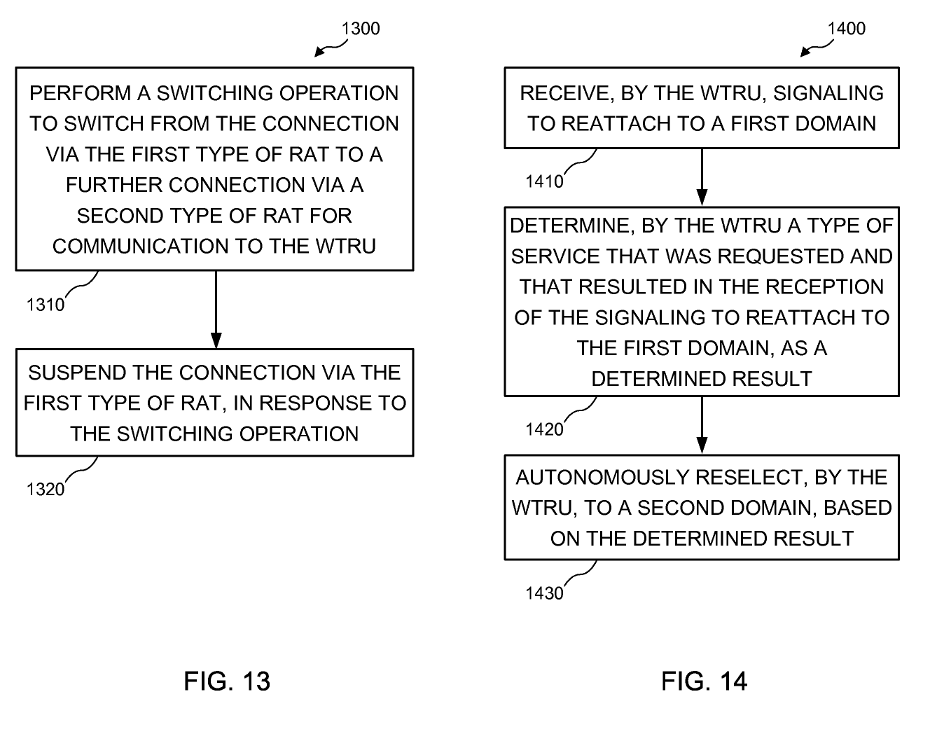

FIG. 13 is a flowchart illustrating a representative method for managing a connection to a WTRU

Referring to FIG. 13, the representative method 1300 may manage the connection via a first type of radio access technology (RAT). At block 1310, a switching operation may be performed to switch from the connection via the first type of RAT to a further connection via a second type of RAT for communication to the WTRU. At block 1320, the connection via the first type of RAT may be suspended, in response to the switching operation.

FIG. 14 is a flowchart illustrating a representative method for managing connections of a WTRU.

Referring to FIG. 14, the representative method 1400 that may manage the connections of the WTRU 102. At block 1410, the WTRU 102 may receive signaling to reattach to the first domain. At block 1420, the WTRU 102 may determine a type of service that was requested (e.g., CSFB) and/or that resulted in the reception of the signaling to reattach to the first domain (or the WTRU 102 may make a determination or verifies whether a request that triggered the reception of a particular establishment cause, was a request for a CSFB service), as a determined result. For example, the determined result may be that the CSFB request caused the reattach signaling because of movement of the WTRU 102 from a LIPA cell, after a LIPA packet data network (PDN) connection was established in a first domain (e.g., an LTE domain). At block 1430, the WTRU 102 may reselect to and/or establish (autonomously establish) a communication (e.g., circuit switched call) in a second domain (e.g., a CSFB enabled domain such as (1) a GSM/EDGE radio access network (GERAN); (2) a UMTS Terrestrial Radio Access Network (UTRAN) and/or (3) a single-carrier Radio Transmission Technology (1xRTT)) based on the determined result (e.g., when the determined result indicates that the service may be served (e.g., better served), for example, on a different cell or network.

In certain representative embodiments, the WTRU 102 may request to initiate a CS call even after reception of signaling to reattach to the first domain (e.g., an LTE domain). In other representative embodiments, the WTRU 102 may receive a circuit switched call even after reception of signaling to reattach to the first domain.

In certain representative embodiments, the circuit switched call may be established in a second domain and may include the WTRU determining whether: (1) to initiate the circuit switched call and/or (2) the WTRU has moved out of the LIPA cell and if both conditions are satisfied (e.g., a desire for the CS call and movement out of the LIPA cell, autonomously establishing, by the WTRU 102, the circuited switched call in a circuit switched domain.

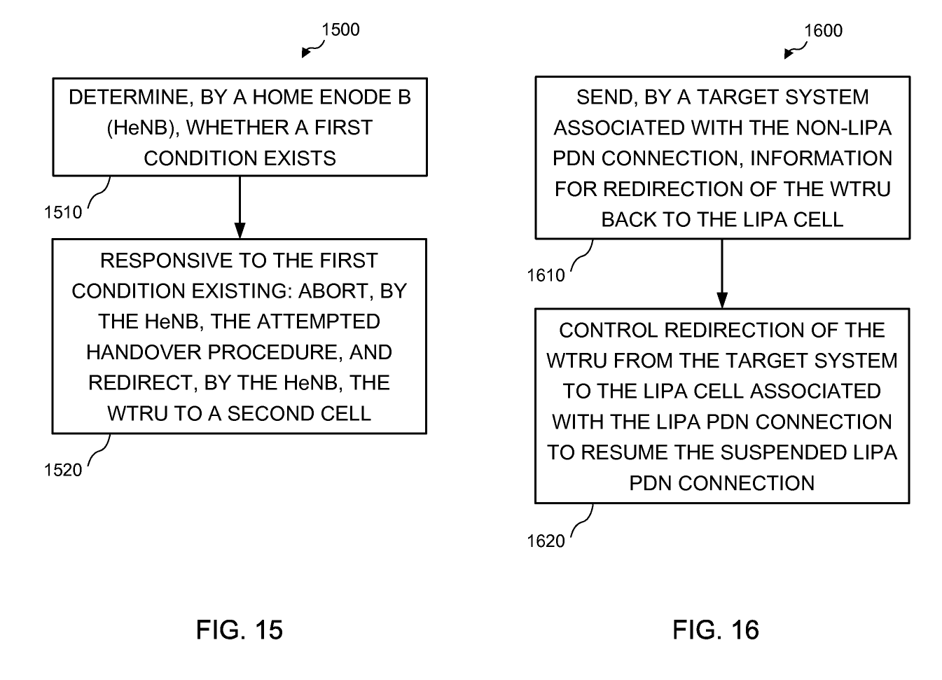

FIG. 15 is a flowchart illustrating a representative method for managing connections of a WTRU.

Referring to FIG. 15, the representative method 1500 may manage connections of the WTRU when attempting a handover of the WTRU having a LIPA PDN connection with a first cell. At block 1510, a HeNB may determine whether a first condition exists (e.g., including at least a part to determine whether the LIPA PDN connection exists). At block 1520, responsive to the first condition existing: (1) the HeNB may abort the attempted handover procedure, and may redirect the WTRU 102 to a second cell.

In certain representative embodiments, the radio resource control (RRC) connection may also be released.

FIG. 16 is a flowchart illustrating a representative method for managing connections of a WTRU.

Referring to FIG. 16, the representative method 1600 may manage a Local Internet Protocol Access (LIPA) packet data network (PDN) connection to a LIPA cell after a switching operation to switch a WTRU from the LIPA PDN connection to a non-LIPA PDN connection for communication. The LIPA PDN connection may be suspended after the switching operation. At block 1610, a target system (e.g., the MSC associated with the non-LIPA PDN connection) may send information (e.g., to it radio access network) for redirection of the WTRU 102 back to the LIPA cell. At block 1620, the target system (e.g., the MSC or other network resources such as the base station) may control (or initiate) redirection of the WTRU 102 from the target system (or domain of the target system) to the LIPA cell associated with the LIPA PDN connection to resume the suspended LIPA PDN connection. For example in certain representative embodiments, the serving node (that is not handling LIPA) may be informed about a pending service.

In certain representative embodiments, the WTRU 102 may attach (or reattach) to the redirected LIPA cell to execute a pending service.

The embodiments disclosed herein may be used in any combination and are applicable to various wireless communication systems, e.g., LTE, GERAN/UTRAN, and the like. The embodiments may also be applicable to SIPTO.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### EMBODIMENTS

In one embodiment, a method of managing a Local Internet Protocol Access (LIPA) packet data network (PDN) connection to a wireless transmit/receive unit (WTRU), may comprise: performing a switching operation to switch from the LIPA PDN connection to a non-LIPA PDN connection for communication to the WTRU; and suspending the LIPA PDN connection, in response to the switching operation.

In one embodiment, the method may further comprise resuming the LIPA PDN connection, after an end of the switching operation.

In one embodiment, the performing of the switching operation may include executing a circuit switched fallback (CSFB) operation.

In one embodiment, the executing of the CSFB operation may include: redirecting the WTRU from a first cell associated with the LIPA PDN connection to a second cell associated with the non-LIPA PDN connection; attaching the WTRU to the second cell; and performing a circuit-switched service.

In one embodiment, the method may further comprise resuming the LIPA PDN connection, in response to an end of the switching operation.

In one embodiment, the suspending of the LIPA PDN connection may include suspending one or more LIPA bearers associated with the LIPA PDN connection.

In one embodiment, the method may further comprise: resuming operation of the one or more LIPA bearers associated with the LIPA connection, after execution of the CSFB operation.

In one embodiment, the performing of the switching operation may include redirecting the WTRU from a first cell associated with the LIPA PDN connection to a second cell associated with a non-LIPA PDN connection, as the serving cell.

In one embodiment, the redirecting from the first cell to the second cell, as the serving cell, may include redirecting to the second cell that is in one of: (1) the same domain and a different cell from the first cell; or (2) a different domain different the first cell.

In one embodiment, the performing of the switching operation includes redirecting, by the WTRU, the WTRU to perform idle mode reselection.

In one embodiment, the method may further comprise: performing a reattachment operation to reattach the WTRU to the second cell.

In one embodiment, the method may further comprise resuming operation of the suspended LIPA PDN connection including: informing a mobile switching center (MSC) associated with the second cell of a CSFB; and sending, by the MSC to a radio network controller (RNC), an indication to redirect the WTRU from the second cell back to the first cell.

In one embodiment, the performing of the switching operation may include: receiving, by a network resource associated with a first domain, a request from the WTRU for a redirection from the first domain to a second domain, and initiating, by the network resource, the redirection of the WTRU to the second domain; and the suspending of the LIPA PDN connection may include: initiating, by the network resource, a suspension of one or more LIPA bearers associated with the LIPA PDN connection.

In one embodiment, the method may further comprise: determining, by the WTRU, a type of communication service associated with a communication; and selectively initiating the switching operation based on the type of communication service associated with the communication.

In one embodiment, responsive to the type of communication service being of a first type, initiating the switching operation and responsive to the type of communication service being of a second type, not initiating the switching operation.

In one embodiment, the first type of communication service may include a circuit-switched service and the second type of communication service may include a packet-switched service.

In one embodiment, the suspending of the LIPA PDN connection may include: determining whether any PDN connection with the WTRU is a non-LIPA PDN connection, as a determined result; and preventing deactivation of the LIPA connection based on the determined result.

In one embodiment, the performing of the switching operation may include:

determining when the communication to be sent over the LIPA PDN connection is of the first type, and sending the first type of communication over the non-LIPA PDN connection; and

the resuming of the LIPA PDN connection may include: determining when the first type of communication has ended, and sending a second type of communication, which is subsequent to the first type of communication, over the LIPA PDN connection.

In one embodiment, the first type of communication may use a circuit-switched service and the second type of communication service may use a packet-switched service.

In one embodiment, the method may further comprise deactivating or resuming the suspended LIPA PDN connection after a specified time period.

In one embodiment, the method may further comprise: determining whether to resume or to deactivate the suspended LIPA PDN connection, in response to an expiration of a suspension period, as a determined result; and deactivating or resuming the LIPA PDN connection in accordance with the determined result.

In one embodiment, the WTRU may be directed or redirected to a target system by the CSFB operation.

In one embodiment, the method may further comprise: attaching, the WTRU to the target system; and controlling redirection from the target system to a local cell (e.g., LIPA cell) associated with the LIPA PDN connection to resume the suspended LIPA PDN connection.

In one embodiment, the method may further comprise: attaching, the WTRU to the target system; and controlling redirection from the target system to a long term evolution (LTE) radio access technology (RAT).

In one embodiment, the method may further comprise: reattaching the WTRU to the redirected local cell, after redirection to the local cell.

In one embodiment, the method may further comprise sending an indication to a network resource or a radio access network associated with the non-LIPA PDN connection to perform a redirection for resuming the suspended LIPA PDN connection, in response to an end of a CSFB operation.

In one embodiment, the method may further comprise: redirecting the WTRU to a local cell associated with the LIPA PDN connection to resume the suspended LIPA PDN connection in response to the sent indication.

In one embodiment, a method of may manage a LIPA PDN connection to a LIPA cell after a switching operation to switch a WTRU from the LIPA PDN connection to a non-LIPA PDN connection for communication.

In one embodiment, the LIPA PDN connection may be suspended after the switching operation.

In one embodiment, the method may comprise sending, by a target system associated with the non-LIPA PDN connection, information for redirection of the WTRU back to the LIPA cell; and controlling redirection of the WTRU from the target system to the LIPA cell associated with the LIPA PDN connection to resume the suspended LIPA PDN connection.

In one embodiment, the method may further comprise attaching the WTRU to the redirected LIPA cell to execute a pending service.

In one embodiment, a method of managing a LIPA PDN connection to a WTRU may comprise: performing a switching operation to switch from the LIPA PDN connection to a non-LIPA PDN connection for communication to the WTRU by locally deactivating the LIPA PDN connection, in response to the switching operation, and initiating an attach procedure.

In one embodiment, the method may further comprise: initiating a tracking area update (TAU) procedure responsive to the WTRU having a PDN connection that is not for LIPA; and indicating active bearers in the WTRU.

In one embodiment, the deactivating of the LIPA PDN connection may be responsive to the WTRU having a PDN connection that is not a LIPA PDN connection.

In one embodiment, the method may comprise: indicating to a mobility management entity (MME) which bearers are active in the WTRU.

In one embodiment, the locally deactivating of the LIPA PDN connection may include locally deactivating the LIPA PDN connection when a closed subscriber group (CSG) subscription expiry is detected.

In one embodiment, the method may further comprise: not rejecting, by a first cell, a received IP multimedia subsystem (IMS) emergency call from the WTRU, responsive to the first cell not being a cell in which the LIPA PDN connection had been provided.

In one embodiment, a method of handling idle mode reselections by a WTRU may comprise: establishing a LIPA PDN connection; moving from one network to another while in idle mode; and informing a mobility management entity (MME) whether or not the WTRU has a LIPA PDN connection.

In one embodiment, the method may further comprise: sending, by the WTRU, an information element (IE) that indicates whether evolved packet system (EPS) bearers are active in the WTRU.

In one embodiment, a method of managing a WTRU context when a closed subscriber group (CSG) subscription expires, may comprise: establishing, by a WTRU, a LIPA PDN connection; attempting, by the WTRU, to access a CSG cell; and receiving, by the WTRU, a message indicating that the WTRU is not authorized to access the CSG after a subscription of the WTRU has expired when the WTRU attempts to access the CSG cell, and the WTRU has one PDN connection for LIPA.

In one embodiment, the method may further comprise locally deactivating bearers of the WTRU that are associated with the LIPA PDN connection without signaling to a mobility management entity (MME).

In one embodiment, a method of placing an emergency call from a WTRU may comprise: sending a service request type with an establishment clause set to emergency; preventing local deregistration of the WTRU using the sent establishment clause; and initiating a packet data network connection for the emergency call.

In one embodiment, a method of handling a LIPA PDN connection may comprise: performing circuit switched fallback; and determining between suspension and deactivation of the LIPA PDN connection.

In one embodiment, a method of managing a connection to a WTRU via a first type of radio access technology (RAT), may comprise: performing a switching operation to switch from the connection via the first type of RAT to a further connection via a second type of RAT for communication to the WTRU; and suspending the connection via the first type of RAT, in response to the switching operation.

In one embodiment, a method of managing connections of a WTRU, may comprise: receiving, by the WTRU, signaling to reattach to a first domain; and determining, by the WTRU whether the WTRU moved from the LIPA cell and had an established LIPA PDN connection, as a determined result; and autonomously establishing, by the WTRU, a circuit-switched call in a second domain, based on the determinate result.

In one embodiment, a method of managing connections of a wireless transmit/receive unit (WTRU), may comprise: receiving, by the WTRU, signaling to reattach to a first domain; determining, by the WTRU a type of service that was requested and that resulted in the reception of the signaling to reattach to the first domain, as a determined result; and autonomously reselecting, by the WTRU, to a second domain, based on the determined result.

In one embodiment, the method may further comprise: ignoring, by the WTRU, the received signal to reattach to the first domain, wherein the autonomously establishing of the circuit-switched call in the second domain may include requesting, by the WTRU, a mobile originated circuit-switched fallback (CSFB) or a mobile terminated CSFB.

In one embodiment, the first domain may be a Long Term Evolution (LTE) domain and the second domain may be a circuit-switched domain.

In one embodiment, the second domain may be one of: (1) a GSM/EDGE radio access network (GERAN); (2) a UMTS Terrestrial Radio Access Network (UTRAN) and/or (3) a single-carrier Radio Transmission Technology (1xRTT).

In one embodiment, a method of managing connections of a wireless transmit/receive unit (WTRU) when attempting a handover of the WTRU having a LIPA packet data network (PDN) connection with a first cell, may comprise: determining, by a Home eNodeB (HeNB), whether a first condition exists; and responsive to the first condition existing: aborting, by the HeNB, the attempted handover procedure, and redirecting, by the HeNB, the WTRU to a second cell.

In one embodiment, the method may further comprise releasing the radio resource control connection.

In one embodiment, the determining of whether the first condition exists may include determining whether the LIPA PDN connection exists.

In one embodiment, a method of managing one or more connections to a WTRU may comprise: performing a switching operation to switch from a first connection to the WTRU to a second connection to the WTRU; and suspending the first connection in response to the switching operation for at least a specified period after performing the switching operation.

In one embodiment, apparatus for managing a LIPA PDN connection, may comprise: a processor configured to: perform a switching operation to switch from the LIPA PDN connection to a non-LIPA PDN connection for communication to a WTRU; and to suspend the LIPA PDN connection, in response to the switching operation.

In one embodiment, the processor may be configured to resume the LIPA PDN connection, after an end of the switching operation.

In one embodiment, the processor may be configured to: (1) determine if the communication with the WTRU is of a first type; and execute a circuit switched fallback (CSFB) operation as part of the switching operation responsive to the communication being of the first type.

In one embodiment, the processor may be configured to resume the LIPA PDN connection, in response to an end of the switching operation.

In one embodiment, the apparatus may further comprise a suspend timer that may be configured to indicate an expiration of a suspension period after the suspension of the LIPA PDN connection, and the processor that may be configured to determine whether to resume or to deactivate the suspended LIPA PDN connection, in response to the expiration of the suspension period; and to deactivate or resume the suspended LIPA PDN connection after the expiration of the suspension period.

In one embodiment, the apparatus may further comprise: a transmit/receive unit configured to inform a target system associated the non-LIPA PDN connection of a pending service for the WTRU and provide redirection information to redirect the WTRU to the suspended LIPA PDN connection for execution of the pending service.

In one embodiment, the processor may be configured to initiate redirection to resume the suspended LIPA PDN connection, in response to an end of a CSFB operation.

In one embodiment, the processor may be configured to: determine whether any PDN connection with the WTRU is a non-LIPA PDN connection, as a determined result; and prevent deactivation of the LIPA connection based on the determined result.

In one embodiment, the processor may be configured to: determine when the communication to be sent over the LIPA PDN connection is of the first type; manage transmission of the first type of communication over the non-LIPA PDN connection; determine when the first type of communication has ended; and manage transmission of a second type of communication, which is subsequent to the first type of communication, over the LIPA PDN connection.

In one embodiment, the first type of communication uses a circuit-switched service, and the second type of communication uses a packet-switched service.

In one embodiment, an apparatus for handling idle mode reselections by a WTRU when moving from one network to another network while in idle mode may comprise: a processor configured to establish a LIPA PDN connection; and a transmit/receive unit configured to inform an MME whether or not the WTRU has a LIPA PDN connection.

In one embodiment, the transmit/receive unit may be configured to send an information element (IE) that indicates whether evolved packet system (EPS) bearers are active for the WTRU.

In one embodiment, an apparatus for managing a WTRU context when a closed subscriber group (CSG) subscription expires may comprise: a processor configured to establish a LIPA PDN connection; and a transmit/receive unit configured to: (1) attempt to access a CSG cell; (2) inform a MME whether or not the WTRU has a LIPA PDN connection; and (3) receive a message indicating that the WTRU is not authorized to access the CSG after a subscription of the WTRU has expired when the WTRU attempts to access the CSG cell, and the WTRU has a single PDN connection for LIPA.

In one embodiment, an apparatus for placing an emergency call, may comprise: a transmit/receive unit configured to send a service request type with an establishment clause set to indicate an emergency from a WTRU; and a processor configured to prevent local deregistration of the WTRU using the sent establishment clause, and initiate a packet data network connection for the emergency call.

In one embodiment, an apparatus for managing a connection via a first type of radio access technology (RAT), may comprise: a processor configured to: control performance of a switching operation to switch from the connection via the first type of RAT to a further connection via a second type of RAT for communication to a WTRU; and suspend the connection via the first type of RAT, in response to the switching operation.

In one embodiment, a WTRU configured to manage connections, that moves from a local internet protocol access (LIPA) cell having had an established LIPA packet data network (PDN) connection in a first domain, may comprise: a transmit/receive unit configured to: (1) request a circuit-switched call, and (2) receive signaling indicating to reattach to the first domain; a processor configured to disregard the received signaling indicating to reattach to the first domain and autonomously control a redirection of the circuit-switched call in a second domain.

In one embodiment, the first domain may be a LTE domain and the second domain may one of: (1) a GSM/EDGE radio access network (GERAN); (2) a UMTS Terrestrial Radio Access Network (UTRAN) or (3) a single-carrier Radio Transmission Technology (1xRTT).

In one embodiment, the processor may be configured to determine whether: (1) to initiate the circuit switched call and (2) the WTRU has moved out of the LIPA cell, as determined results; and in response to the determined results, autonomously redirect the WTRU, to a circuit-switched domain, as the second domain.

In one embodiment, a Home eNodeB (HeNB) for managing connections when attempting a handover of a WTRU having a LIPA PDN connection with a first cell, may comprise: a processor configure to: (1) determine whether a first condition exists, and (2) responsive to the first condition: (i) abort the attempted handover procedure, and (ii) redirect the WTRU to a second cell; and (3) release a radio resource control connection.

In one embodiment, the processor may be configured to determine whether the LIPA PDN connection exists, as at least a part of the first condition.

In one embodiment, a non-transitory computer readable storage medium may store computer code executable by a computer for implementing any of the above methods.

What is claimed is:

1. A method of managing a Local Internet Protocol Access (LIPA) packet data network (PDN) connection to a wireless transmit/receive unit (WTRU), the method comprising:
performing a switching operation to switch from the LIPA PDN connection to a non-LIPA PDN connection for communication to the WTRU; and
suspending the LIPA PDN connection, in response to the switching operation.

2. The method of claim 1, further comprising resuming the LIPA PDN connection after an end of the switching operation.

3. The method of claim 2, wherein the performing of the switching operation includes executing a circuit switched fallback (CSFB) operation.

4. The method of claim 1, further comprising resuming the LIPA PDN connection, in response to an end of the switching operation.

5. The method of claim 1, wherein the suspending of the LIPA PDN connection includes suspending one or more LIPA bearers associated with the LIPA PDN connection.

6. The method of claim 1, wherein the performing of the switching operation includes redirecting the WTRU from a first cell associated with the LIPA PDN connection to a second cell associated with a non-LIPA PDN connection, as the serving cell.

7. The method of claim 6, wherein the redirecting from the first cell to the second cell includes redirecting to the second cell that is in one of: (1) a same domain and a different cell from the first cell; or (2) a different domain different from the first cell.

8. The method of claim 6, wherein the performing of the switching operation includes redirecting, by the WTRU, the WTRU to perform idle mode reselection.

9. The method of claim 1, wherein:
the performing of the switching operation includes:
receiving, by a network resource associated with a first domain, a request from the WTRU for a redirection from the first domain to a second domain, and
initiating, by the network resource, the redirection of the WTRU to the second domain; and
the suspending of the LIPA PDN connection includes:
initiating, by the network resource, a suspension of one or more LIPA bearers associated with the LIPA PDN connection.

10. The method of claim 1, wherein the suspending of the LIPA PDN connection includes:
determining whether any PDN connection with the WTRU is a non-LIPA PDN connection, as a determined result; and
preventing deactivation of the LIPA connection based on the determined result.

11. The method of claim 1, further comprising deactivating or resuming the suspended LIPA PDN connection after a specified time period.

12. The method of claim 1, wherein the WTRU is directed to a target system by the CSFB operation, the method further comprising:
attaching, the WTRU to the target system; and
controlling redirection from the target system to a long term evolution (LTE) radio access technology (RAT).

13. The method of claim 12, further comprising:
reattaching the WTRU to the redirected LTE RAT, after redirection from the target system.

14. The method of claim 1, further comprising sending an indication to a network resource or a radio access network associated with the non-LIPA PDN connection to perform a redirection.

15. The method of claim 1, further comprising:
performing the redirection for resumption of the suspended LIPA PDN connection, in response to an end of a Circuit Switched Fallback (CSFB) operation.

16. The method of claim 14, further comprising:
redirecting the WTRU to a local cell associated with the LIPA PDN connection to resume the suspended LIPA PDN connection in response to the sent indication.

17. A method of managing a Local Internet Protocol Access (LIPA) packet data network (PDN) connection to a LIPA cell after a switching operation to switch a wireless transmit/receive unit (WTRU) from the LIPA PDN connection to a non-LIPA PDN connection for communication, the LIPA PDN connection being suspended after the switching operation, the method comprising:
sending, by a target system associated with the non-LIPA PDN connection, information for redirection of the WTRU back to the LIPA cell; and
controlling redirection of the WTRU from the target system to the LIPA cell associated with the LIPA PDN connection to resume the suspended LIPA PDN connection.

18. A method of managing a connection of a wireless transmit/receive unit (WTRU), the method comprising:
receiving, by the WTRU, signaling to reattach to a first domain;
determining, by the WTRU, a type of service that was requested and that resulted in the reception of the signaling to reattach to the first domain, as a determined result; and
autonomously reselecting, by the WTRU, to a second domain based on the determined result.

19. The method of claim 18, further comprising:
ignoring, by the WTRU, the received signal to reattach to the first domain; and
establishing a circuit-switched call in the second domain after autonomous reselection.

20. The method of claim 19, wherein the establishing of the circuit-switched call in the second domain includes requesting, by the WTRU, a mobile originated circuit-switched fallback (CSFB) or a mobile terminated CSFB.

21. A method of managing connections of a wireless transmit/receive unit (WTRU) when attempting a handover of the WTRU having a LIPA packet data network (PDN) connection with a first cell, the method comprising:
determining, by a Home eNodeB (HeNB), whether a first condition exists; and
responsive to the first condition existing:
preventing, by the HeNB, the attempted handover procedure, and
redirecting, by the HeNB, the WTRU to a second cell.

22. Apparatus for managing a Local Internet Protocol Access (LIPA) packet data network (PDN) connection, comprising:
a processor configured to:
perform a switching operation to switch from the LIPA PDN connection to a non-LIPA PDN connection for communication to a wireless transmit/receive unit (WTRU); and
suspend the LIPA PDN connection, in response to the switching operation.

23. The apparatus of claim 22, further comprising
a suspend timer configured to indicate an expiration of a suspension period after the suspension of the LIPA PDN connection, wherein the processor is configured to: (1) determine whether to resume or to deactivate the suspended LIPA PDN connection, in response to the expiration of the suspension period; and (2) deactivate or resume the suspended LIPA PDN connection after the expiration of the suspension period.

24. The apparatus of claim 22, wherein the processor is configured to initiate redirection to resume the suspended LIPA PDN connection, in response to an end of a Circuit Switched Fallback (CSFB) operation.

25. The apparatus of claim 22, wherein the processor is configured to:
determine whether any PDN connection with the WTRU is a non-LIPA PDN connection, as a determined result; and
prevent deactivation of the LIPA connection based on the determined result.

26. A wireless transmit/receive unit (WTRU), configured to manage connections to first and second domains, comprising:
a transmit/receive unit configured to: (1) request a circuit-switched call, and (2) receive signaling indicating to reattach to the first domain; and
a processor configured to disregard the received signaling indicating to reattach to the first domain and autonomously control a redirection of the circuit-switched call from the first domain to the second domain.
